(19) United States
(12) Patent Application Publication
(10) Pub. No.: US 2007/0156481 A1
(43) Pub. Date: Jul. 5, 2007

(54) Method for purchasing and supplying super retail stores through combining and/or sharing resources used to supply super retail stores among retailers

(75) Inventor: George Cox Beighley JR., Columbia, SC (US)

Correspondence Address: GEORGE COX BEIGHLEY, JR., 6 OLD MILL COURT, COLUMBIA, SC, 29206, US

(73) Assignee: George Cox Beighley JR., Columbia, SC (US)

(21) Appl. No.: 11/306,512

(22) Filed: Dec. 30, 2005

(51) Int. Cl. G06F 9/46

(52) U.S. Cl. 705/8

(57) ABSTRACT

A method for supplying a super retail store by a business organization operating or seeking to operate super retail stores, through combining partially, combining entirely, sharing partially, sharing entirely, combining partially and sharing partially, and combining partially and sharing entirely resources used to supply super retail stores with another business organization or other business organizations operating or seeking to operate super retail stores is described. The method involves a collaborative agreement among business organizations to share or combine partially or entirely corporate resources used to supply their individual stores.

### FIELD OF THE INVENTION

The present invention relates to super retail stores, and more particularly to a method of supplying the goods sold in super retail stores through combining and/or sharing, partially or entirely resources used to supply super retail stores among parties operating or seeking to operate super retail stores. The present invention also relates to a method of supplying the goods sold in super retail stores by purchasing collectively some or all goods from common manufactures by parties operating or seeking to operate super retail stores.

### BACKGROUND OF THE INVENTION

1. Prior Art

Currently, there are many retailers operating specific or general super retail stores. The following list is not completely inclusive but serves to illustrate the general type of corporations, which currently operate super retail stores: Wal-Mart, Sears Holding Corporation, Target, and Kroger. Currently, Wal-Mart operates 1,713 super retail stores within the United States. Target operates 158 super retail stores. Sears Holding Corporation, operates 57 super retail centers under the name Big K-Mart, and 8 super retail stores under the name Sears Grand. Kroger Stores operates 147 super retail stores. The following is a list of some of the specialized retailers, which have the potential to form super retail stores: Publix's Markets, Bed, Bath, and Beyond, Lien's and Things, Home Depot Stores, Lowe's Stores, Best Buy, Circuit City, Office Max, Staples, Office Depot, Pier 1 imports, Radio Shack, Dillard's.

Supplying a store is similar for virtually all retail business organizations. First, the business organization purchases the merchandise from a manufacturer or supplier. Second, the business organization transports or arranges for the transportation of merchandise from the manufacturer or supplier to a retail store or a storage facility. Third, the business organization offers the merchandise for sale to the public.

Most retailers have similar resources used to supply their super retail stores. For example, usually, distribution managers oversee and manage the goods from the time of purchase to the time they are stored or offered for sale in the super retail store. Additionally, most retail business organizations have similar computer programs which manage track, order, and ship goods.

Currently, Wal-Mart has at least ten times as many super centers as does any other individual super retailer. Consequently, Wal-Mart purchases roughly ten times the amount of merchandise from manufactures, which allows Wal-Mart to get a lower price for the same or similar merchandise than other retail corporations. Wal-Mart has an overwhelming domination in the market of super retail stores, which forces competitors operating super retail stores to come up with different more effective methods of supplying their stores. This patent presents the business process of supplying super retail stores through retailer's sharing and/or combing their supply resources and purchasing collectively as a method of being competitive.

2. Unsolved Problems in Prior Art

No retail business organization in the super retail industry has ever combined or shared resources used to supply their stores without merging corporations. The idea of combining or sharing resources used to supply stores only, while maintaining separate ownership of the super retail stores and other corporate assets has never been presented to the public or acted upon by any corporation operating super retail stores. Combining or sharing the assets the retailers use to supply their super retail stores will allow them to minimize excess expenditures, and compete against Wal-Mart on volume. Additionally, smaller specialized retailers could use this patent in order to remain competitive with larger retail corporations, which have a greater share of the super retail market.

### OBJECTS OF THE INVENTION

It is therefore an object of the invention to provide a method for supplying super retail stores by a retailer, who combines partially resources used to supply super retail stores with the resources used to supply super retail stores of another retailer or other retailers.

It is another object of the invention to provide a method for supplying super retail stores by a retailer, who combines entirely resources used to supply super retail stores with the resources used to supply super retail stores of another retailer or other retailers.

Another object of the invention is to provide a method for supplying super retail stores by a retailer, who shares partially resources used to supply super retail stores with the resources used to supply super retail stores of another retailer or other retailers.

It is a further object of the invention to provide a method for supplying super retail stores by a retailer, who shares entirely resources used to supply super retail stores with the resources used to supply super retail stores of another retailer or other retailers.

Another object of the invention is to provide a method for supplying super retail stores by a retailer, who combines partially and shares partially resources used to supply super retail stores with the resources used to supply super retail stores of another retailer or other retailers.

It is a further object of the invention to provide a method for supplying super retail stores by a retailer, who combines partially and shares entirely resources used to supply super retail stores with the resources used to supply super retail stores of another retailer or other retailers.

Yet another object of the invention is to provide a method for supplying super retail stores by a retailer, who purchases collectively with other retailers some or all goods from common manufacturers.

### SUMMARY OF THE INVENTION: EXACT NATURE

The present invention relates to a method for supplying super retail store by a business organization operating or seeking to operate super retail stores, which comprises: (1) combining partially resources used to supply super retail stores with the resources used to supply super retail stores of another business organization or other business organizations, who operate(s) or seek(s) to operate super retail stores; (2) purchasing collectively some or all goods from common manufactures; (3) purchasing and supplying super retail stores using the additional resources. An example, discussed below, of three fictional corporations, Corporation A, Corporation B, and Corporation C, (hereinafter A, B, C) who use the above mention process, shows the process provides a concrete and tangible change to how a business organization supplies super retails stores. Essentially, previously A, B, and C separately managed, transported, stored all their merchandise; now A, B, or C or a subsidiary organization manages, transports, and stores some merchandise and A, B, and C separately supply the remaining merchandise to their stores. Additionally, previously A, B, and C separately purchased merchandise from the same manufacturers; now A, B, and C purchase collectively some or all merchandise from common manufacturers.

In order to combine partially and purchase collectively, a business organization operating or seeking to operate super retail stores would need to enter into a collaborative agreement with another business organization or other business organizations, who operate(s) or seek (s) to operate super retail stores, to combine partially resources used to supply super retail stores and to purchase collectively some or all goods from common manufactures. An example follows. Corporations A, B and C create and determine the management of a subsidiary organization in the form a general partnership called “X Corp.” Corporations A, B and C enter into a contract, which specifies the following example terms: (1) which resources used to supply super retail stores each party will transfer to X Corp in exchange for shares in X Corp, (2) the common manufactures from whom the parties will purchase goods from collectively, (3) the amount of yearly assets the parties will pay to maintain X Corp, (4) which stores, the parties will be contractually bound to allow X Corp to supply, (5) which merchandise, the parties will be contractually bound to allow X Corp to supply.

Part one of the process involves a business organization, who operates or seeks to operate super retail stores, combining partially resources used to supply super retail stores with the resources used to supply super retail stores of another business organization or other business organizations, who operate(s) or seek(s) to operate super retail stores. An example follows. X Corp, a subsidiary organization of A, B, and C, acquires the computer management, tracking, and ordering software of Corporations A, B, and C. X Corp acquires some of the trucks, personnel, warehouses, and contractual agreements relating to supplying the stores of Corporations A, B and C. X Corp owns, operates, controls, and assumes liability for the resources, which Corporation A, B, and C transferred to X Corp in exchange for shares in X Corp. X Corp supplies some merchandise to super retail stores belonging to the different corporations, A, B, and C. Additionally, A, B, and C separately supply their super retail stores with some merchandise.

Part two of the process involves business organizations, who operate or seek to operate super retail stores, purchasing collectively some or all goods from common manufactures. An example follows. Corporations A, B, and C specify in a contract that through X Corp they will collectively purchase all merchandise they previously purchased separately from the same manufacturers. Corporations A, B, and C previously purchased chairs and bread from the same manufacturers. X Corp orders and purchases chairs, and bread for A, B, and C.

Part three of the process involves business organizations, who operate super retail stores purchasing and supplying their super retail stores using the additional resources. An example follows. The following purchasing takes place. X Crop purchases the merchandise sold by common manufacturers. Corporation A purchases merchandise sold only in Corporation A's super retail stores. Corporation B purchases merchandise sold only in Corporation B's super retail stores. Corporation C purchases merchandise sold only in Corporation C's super retail stores. The following supplying takes place. X Corp, owned by Corporations A, B, and C, uses the resources used to supply super retail stores, which Corporations A, B, and C, transferred to it, to supply super retail stores belonging to the different corporations A, B, and C, with some merchandise. Corporation A supplies some merchandise to super retail stores belonging to Corporation A. Corporation B supplies some merchandise to super retail stores belonging to Corporation B. Corporation C supplies some merchandise to super retail stores belonging to Corporation C. X Corp orders, manages, tracks, transports goods from the manufacturer to the super retail store.

Further, the present invention relates to a method for supplying a super retail store by a business organization operating or seeking to operate super retail stores, which comprises: (1) combining partially resources used to supply super retail stores with the resources used to supply super retail stores of another business organization or other business organizations, who operate(s) or seek(s) to operate super retail stores; (2) supplying super retail stores using the additional resources. An example, discussed below, of three fictional corporations, Corporation A, Corporation B, and Corporation C, (hereinafter A, B, C) who use the above mention process, shows the process provides a concrete and tangible change to how a business organization supplies super retails stores. Essentially, previously A, B, and C separately managed, transported, stored all their merchandise; now A, B, or C or a subsidiary organization manages, transports, and stores some merchandise and A, B, and C separately supply the remaining merchandise to their stores.

In order to combine partially a business organization, operating or seeking to operate super retail stores, would need to enter into a collaborative agreement with another business organization or other business organizations, operating or seeking to operate super retail stores, to combine partially resources used to supply super retail stores. An example follows. Corporations A, B and C create and determine the management of a subsidiary organization in the form of a general partnership called “X Corp.” Corporations A, B and C enter into a contract, which specifies the following example terms: (1) which resources used to supply super retail stores each party will transfer to X Corp in exchange for shares in X Corp, (2) the amount of yearly assets the parties will pay to maintain X Corp, (3) which stores, the parties will be contractually bound to allow X Corp to supply, (4) which merchandise, the parties will be contractually bound to allow X Corp to supply.

Part one of the process involves a business organization, who operates or seeks to operate super retail stores, combining partially resources used to supply super retail stores with the resources used to supply super retail stores of another business organization or other business organizations, who operate or seek to operate super retail stores. An example follows. X Corp, a subsidiary organization of A, B, and C, acquires the computer management, tracking, and ordering software of Corporations A, B, and C. X Corp acquires some of the trucks, personnel, warehouses, and contractual agreements relating to supplying the stores of Corporations A, B and C. X Corp owns, operates, controls, and assumes liability for the resources, which Corporation A, B, and C transferred to X Corp in exchange for shares in X Corp. X Corp supplies some merchandise to super retail stores belonging to the different corporations, A, B, and C. Additionally, A, B, and C separately supply their super retail stores with some merchandise.

Part two of the process involves business organizations, who operate or seek to operate super retail stores supplying their super retail stores using the additional resources. An example follows. X Corp, owned by Corporations A, B, and C, uses the resources used to supply super retail stores, which Corporations A, B, and C, transferred to it, to supply super retail stores belonging to Corporations A, B, and C, with some merchandise. Corporation A supplies some merchandise to super retail stores belonging to Corporation A. Corporation B supplies some merchandise to super retail stores belonging to Corporation B. Corporation C supplies some merchandise to super retail stores belonging to Corporation C. X Corp orders, manages, tracks, transports goods from the manufacturer to the super retail store.

Further, the present invention relates to a method for supplying super retail store by a business organization operating or seeking to operate super retail stores, which comprises: (1) combining entirely resources used to supply super retail stores with the resources used to supply super retail stores of another business organization or other business organizations, who operate(s) or seek(s) to operate super retail stores; (2) purchasing collectively some or all goods from common manufacturers; (3) purchasing and supplying super retail stores using the additional resources. An example, discussed below, of two fictional corporations, Corporation A, Corporation B, (hereinafter A, B) who use the above mention process, shows the process provides a concrete and tangible change to how super retails stores are supplied. Previously A and B separately managed, transported and stored all merchandise for sale in their stores; now A, B, or a subsidiary organization manages, transports and stores all merchandise for sale in stores belonging to the different corporations A and B. Additionally, previously A and B separately purchased merchandise from the same manufacturers; now A and B purchase collectively some or all merchandise from common manufacturers.

In order to combine entirely and purchase collectively, a business organization operating or seeking to operate super retail stores would need to enter into a collaborative agreement with another business organization or other business organizations, who operate(s) or seek (s) to operate super retail stores, to combine entirely resources used to supply super retail stores and to purchase collectively some or all goods from common manufactures. An example follows. A and B enter into a contract, which addresses the following essential terms: (1) Corporation B will transfer all of Corporation B's resources used to supply super retail stores to Corporation in exchange for shares in Corporation A and Corporation A's obligation to supply Corporation B's super retail stores, (2) the common manufactures from whom the parties will purchase goods from collectively, (3) how the merchandise purchased collectively will be purchased, ordered, transported, and stored (4) how the merchandise purchased individually by Corporation B will be supplied to Corporation B's super retail stores by Corporation A, (5) the super retail stores operated by Corporation B, which Corporation A will supply, (6) which merchandise, Corporation A will supply to Corporation B's super retail stores, (7) the amount of capital Corporation B will pay to Corporation A to supply Corporation B's super retail stores.

Part one of the process involves a business organization, who operates or seeks to operate super retail stores, combining entirely resources used to supply super retail stores with the resources used to supply super retail stores of another business organization or other business organizations, who operate(s) or seek(s) to operate super retail stores. An example follows. Corporation A acquires all of the resources Corporation B used to supply its super retail stores, such as the warehouses, trucks, employees, and contractual agreements relating to supplying the super retail stores. Corporation A is obligated contractually to supply all the merchandise Corporation B sells in its super retail stores to all of Corporation B's super retail stores. Corporation B owns shares in Corporation A, and agrees to pay Corporation A capital each year to supply Corporation B's super retail stores. All of the resources used to supply stores for Corporation A and B are combined and under the ownership and control of Corporation A subject to the contractual agreement.

Part two of the process involves business organizations, who operate or seek to operate super retail stores, purchasing collectively some or all goods from common manufactures. An example follows. Corporation A and B agree in a contract that Corporation B will do all of the purchasing of merchandise from common manufactures. For example, the parties specify in the contract that collectively they will purchase chairs, and bread, which they previously purchased individually form the same manufacturers. Corporation B orders and purchases merchandise from common manufactures, such as the bread and chairs, for sale in super retails stores operated by Corporation A and super retail stores operated by Corporation B.

Part three of the process involves business organizations, who operate super retail stores purchasing and supplying their super retail stores using the additional resources. An example follows. The following purchasing takes of merchandise takes place. Corporation B purchases common merchandise for sale in super retail stores operated by Corporation A and super retail stores operated by Corporation B. Corporation A purchases individual merchandise for sale in its super retail stores. Corporation B purchases individual merchandise for sale in its super retail stores. The following supplying takes place. Corporation A supplies the merchandise it purchased individually and its share of the merchandise, which Corporation B purchased for the collective use, to super retail stores belonging to Corporation A. Corporation A supplies the merchandise Corporation B purchased individually, and the share of the merchandise, which Corporation B purchased for the collective use, to super retail stores belonging to Corporation B.

Further, the present invention relates to a method for supplying a super retail store by a business organization operating or seeking to operate super retail stores, which comprises: (1) combining entirely resources used to supply super retail stores with the resources used to supply super retail stores of another business organization or other business organizations, who operate(s) or seek(s) to operate super retail stores; (2) supplying super retail stores using the additional resources. An example, discussed below, of two fictional corporations, Corporation A, Corporation B, (hereinafter A, B) who use the above mention process, shows the process provides a concrete and tangible change to how super retails stores are supplied. Previously A and B separately managed, transported and stored all merchandise for sale in their stores; now A, B, or a subsidiary organization manages, transports and stores all merchandise for sale in stores belonging to the different corporations A and B.

In order to combine entirely a business organization, operating or seeking to operate super retail stores, would need to enter into a collaborative agreement with another business organization or other business organizations, operating or seeking to operate super retail stores, to combine entirely resources used to supply super retail stores. An example follows. Corporation A and Corporation B enter into a contract, which addresses the following essential terms: (1) Corporation B will transfer all of Corporation B's resources used to supply super retail stores to Corporation in exchange for shares in Corporation A and Corporation A's obligation to supply Corporation B's super retail stores, (2) how the merchandise purchased individually by Corporation B will be supplied to Corporation B's super retail stores by Corporation A, (3) the super retail stores operated by Corporation B, which Corporation A will supply, (4) which merchandise, Corporation A will supply to Corporation B's super retail stores, (5) the amount of capital Corporation B will pay to Corporation A to supply Corporation B's super retail stores.

Part one of the process involves a business organization, who operates or seeks to operate super retail stores, combining entirely resources used to supply super retail stores with the resources used to supply super retail stores of another business organization or other business organizations, who operate or seek to operate super retail stores. An example follows. Corporation A acquires all of the resources Corporation B used to supply its super retail stores, such as the warehouses, trucks, employees, and contractual agreements relating to supplying the super retail stores. Corporation A is obligated contractually to supply all the merchandise Corporation B sells in its super retail stores to all of Corporation B's super retail stores. Corporation B owns shares in Corporation A, and agrees to pay Corporation A capital each year to supply Corporation B's super retail stores. All of the resources used to supply stores for Corporation A and B are combined and under the ownership and control of Corporation A subject to the contractual agreement.

Part two of the process involves business organizations, who operate or seek to operate super retail stores supplying their super retail stores using the additional resources. An example follows. The following supplying takes place. Corporation A supplies the merchandise it purchased individually to super retail stores belonging to Corporation A. Additionally, Corporation A supplies the merchandise Corporation B purchased individually to super retail stores belonging to Corporation B.

Further, the present invention relates to a method for supplying super retail store by a business organization operating or seeking to operate super retail stores, which comprises: (1) sharing partially resources used to supply super retail stores with the resources used to supply super retail stores of another business organization or other business organizations, who operate(s) or seek(s) to operate super retail stores; (2) purchasing collectively some or all goods from common manufactures; (3) purchasing and supplying super retail stores using the additional resources. An example, discussed below, of three fictional corporations, Corporation A, Corporation B, and Corporation C, who use the above mention process, shows the process provides a concrete and tangible change to the process of supplying super retails stores. Previously A, B, and C used their individual supply resources to manage, transport, and store some merchandise; now A, B, and C, use some of each others supply resources to manage, transport, and store the merchandise. Additionally, previously A, B, and C separately purchased merchandise from the same manufacturers; now A, B, and C purchase collectively some or all merchandise from common manufacturers.

In order to share partially and purchase collectively, a business organization operating or seeking to operate super retail stores would need to enter into a collaborative agreement with another business organization or other business organizations, who operate(s) or seek (s) to operate super retail stores, to share partially resources used to supply super retail stores and to purchase collectively some or all goods from common manufactures. An example follows. Corporation A, Corporation B, and Corporation C enter into a strategic alliance, which discusses the following example conditions: (1) which resources used to supply super retail stores, which party will have a right to use, such as Corporation C having a right to use some of Corporation B's warehouses, and Corporation A having a right to use Corporation C's trucks; (2) the common manufactures from whom the parties will purchase goods from collectively, (3) the amount of capital the parties will pay to each other to maintain the right of use.

Part one of the process involves a business organization, who operates or seeks to operate super retail stores, sharing partially resources used to supply super retail stores with the resources used to supply super retail stores of another business organization or other business organizations, who operate(s) or seek(s) to operate super retail stores. An example follows. In the strategic alliance agreement, Corporation A acquires the right to use some warehouses belonging to Corporation B, and the right to use some trucks belonging to Corporation C. Corporation B acquires the right to use some warehouses belonging to Corporation C and some trucks belonging to Corporation A. Corporation C acquires the right to use some trucks belonging to Corporation B, and some warehouses belonging to Corporation A. Corporation A, B, and C, individually determine how their products will get from the manufacturers to their super retail stores using the newly available resources, and without the resources given away under the agreement.

Part two of the process involves business organizations, who operate or seek to operate super retail stores, purchasing collectively some or all goods from common manufactures. An example follows. In the strategic alliance agreement Corporations A, B, and C agree: A will purchase all the hardware sold to Corporations A, B, and C by common manufacturers, B will purchase all the garden products sold to Corporations A, B, and C by common manufacturers, and C will purchase all the groceries sold to Corporations A, B, and C by common manufacturers. Corporation A purchases all the hardware sold to Corporations A, B, and C by common manufacturers. Corporation B purchases all the garden products sold to Corporations A, B, and C by common manufacturers. C purchases all the groceries sold to Corporations A, B, and C by common manufacturers.

Part three of the process involves business organizations, who operate super retail stores purchasing and supplying their super retail stores using the additional resources. An example follows. The following purchasing takes place. Corporation A purchases all the hardware. Corporation B purchases all the garden products. Corporation C purchases all the groceries. The following supplying takes place. Corporation A supplies super retail stores belonging to Corporation A using Corporation A's resources used to supply super retail stores, which includes using some warehouses belonging to Corporation B and some trucks belonging to Corporation C. Corporation B supplies super retail stores belonging to Corporation B using Corporation B's resources used to supply super retail stores, which includes some warehouses belonging to Corporation C and some trucks belonging to Corporation A. Corporation C supplies super retail stores belonging to Corporation C using Corporation C's resources used to supply super retail stores, which includes some trucks belonging to Corporation B and some warehouses belonging to Corporation A. Corporations A, B, and C share with each other their computer management, ordering and tracking software. Each Corporation supplies its own stores, with the additional resources acquired through the strategic alliance and without the resources, which they allowed others to use under the strategic alliance agreement.

Further, the present invention relates to a method for supplying a super retail store by a business organization operating or seeking to operate super retail stores, which comprises: (1) sharing partially resources used to supply super retail stores with the resources used to supply super retail stores of another business organization or other business organizations, who operate(s) or seek(s) to operate super retail stores; (2) supplying super retail stores using the additional resources. An example, discussed below, of three fictional corporations, Corporation A, Corporation B, and Corporation C, who use the above mention process, shows the process provides a concrete and tangible change to the process of supplying super retails stores. Previously A, B, and C used their individual supply resources to manage, transport, and store some merchandise; now A, B, and C, use some of each others supply resources to manage, transport, and store the merchandise.

In order to share partially a business organization, operating or seeking to operate super retail stores, would need to enter into a collaborative agreement with another business organization or other business organizations, operating or seeking to operate super retail stores, to share partially resources used to supply super retail stores. An example follows. Corporation A, Corporation B, and Corporation C enter into a strategic alliance, which discusses the following example conditions: (1) which resources used to supply super retail stores, which party will have a right to use, (2) the amount of capital the parties will pay to each other to maintain the right of use.

Part one of the process involves a business organization, who operates or seeks to operate super retail stores, sharing partially resources used to supply super retail stores with the resources used to supply super retail stores of another business organization or other business organizations, who operate or seek to operate super retail stores. An example follows. In the strategic alliance agreement, Corporation A acquires the right to use some warehouses belonging to Corporation B, and the right to use some trucks belonging to Corporation C. Corporation B acquires the right to use some warehouses belonging to Corporation C and some trucks belonging to Corporation A. Corporation C acquires the right to use some trucks belonging to Corporation B, and some warehouses belonging to Corporation A. Corporation A, B, and C, separately determine how their products will get from the manufacturers to their super retail stores using the newly available resources, and without the resources given away under the agreement.

Part two of the process involves business organizations, who operate or seek to operate super retail stores supplying their super retail stores using the additional resources. An example follows. The following supplying takes place. Corporation A supplies super retail stores belonging to Corporation A using Corporation A's resources used to supply super retail stores, which includes using some warehouses belonging to Corporation B and some trucks belonging to Corporation C. Corporation B supplies super retail stores belonging to Corporation B using Corporation B's resources used to supply super retail stores, which includes some warehouses belonging to Corporation C and some trucks belonging to Corporation A. Corporation C supplies super retail stores belonging to Corporation C using Corporation C's resources used to supply super retail stores, which includes some trucks belonging to Corporation B and some warehouses belonging to Corporation A. Corporations A, B, and C share with each other their computer management, ordering and tracking software. Each Corporation supplies its own stores, with the additional resources acquired through the strategic alliance and without the resources, which they allowed others to use under the strategic alliance agreement.

The present invention relates to a method for supplying super retail store by a business organization operating or seeking to operate super retail stores, which comprises: (1) sharing entirely resources used to supply super retail stores with the resources used to supply super retail stores of another business organization or other business organizations, who operate(s) or seek(s) to operate super retail stores; (2) purchasing collectively some or all goods from common manufactures; (3) purchasing and supplying super retail stores using the additional resources. An example, discussed below, of two fictional corporations, Corporation A and Corporation B, (hereinafter A, and B) who use the above mention process, shows the process provides a concrete and tangible change to how super retails stores are supplied. Previously A and B used their individual supply resources to manage, transport, and store merchandise; now A and B, have a right to use all of each others supply resources to manage, transport, and store merchandise. Additionally, previously A, B, and C separately purchased merchandise from the same manufacturers; now A, B, and C purchase collectively some or all merchandise from common manufacturers.

In order to share entirely and purchase collectively, a business organization operating or seeking to operate super retail stores would need to enter into a collaborative agreement with another business organization or other business organizations, who operate(s) or seek (s) to operate super retail stores, to share entirely resources used to supply super retail stores and to purchase collectively some or all goods from common manufactures. An example follows. Corporation A, and Corporation B, enter into a joint-venture agreement, which discusses the following example terms: (1) that each party to the agreement will have the right to use the resources used to supply super retail stores of all parties to the agreement, (2) a governing body composed of representatives of A and B, yet under control of A and B individually, which determines which corporation has priority over which resources, (3) the common manufacturers from whom the parties will purchase goods from collectively, (4) the amount of capital the parties will pay to each other to maintain the right of use.

Part one of the process involves a business organization, who operates or seeks to operate super retail stores, sharing entirely resources used to supply super retail stores with the resources used to supply super retail stores of another business organization or other business organizations, who operate(s) or seek(s) to operate super retail stores. An example follows. Corporations A and B create similar internal committees, who work cooperatively with each other to determine who has priority of given resources. For example the committees could determine that Corporation A has a need to use Corporation B's trucks and warehouses on given date to supply super retail stores belong to Corporation A with a shipment of merchandise that arrives on that date, and Corporation B would have priority on another date for a similar reason. Additionally, Corporations A and B acquire each others computer ordering, tracking, and managing software.

Part two of the process involves business organizations, who operate or seek to operate super retail stores, purchasing collectively some or all goods from common manufactures. An example follows. Corporation A and B agree in a contract that Corporation B will do all of the purchasing of merchandise from common manufactures. For example, the parties specify in the contract that collectively they will purchase chairs, and bread, which they previously purchased individually form the same manufacturers. Corporation B orders and purchases merchandise from common manufactures, such as the bread and chairs, for sale in super retails stores operated by Corporation A and super retail stores operated by Corporation B.

Part three of the process involves business organizations, who operate super retail stores purchasing and supplying their super retail stores using the additional resources. An example follows. The following purchasing takes of merchandise takes place. Corporation B purchases common merchandise for sale in super retail stores operated by Corporation A and super retail stores operated by Corporation B. Corporation A purchases individual merchandise for sale in its super retail stores. Corporation B purchases individual merchandise for sale in its super retail stores. The following supplying takes place. Corporation A using the resources used to supply super retail stores of Corporation A and B supplies the merchandise Corporation A purchased and its share of the merchandise, which Corporation B purchased for the collective use, to super retail stores belonging to Corporation A. Corporation B using the resources used to supply super retail stores of Corporation A and B supplies the merchandise Corporation B purchased and its share of the merchandise, which Corporation A purchased for the collective use, to super retail stores belonging to Corporation B.

Further, the present invention relates to a method for supplying a super retail store by a business organization operating or seeking to operate super retail stores, which comprises: (1) sharing entirely resources used to supply super retail stores with the resources used to supply super retail stores of another business organization or other business organizations, who operate(s) or seek(s) to operate super retail stores; (2) supplying super retail stores using the additional resources. Previously A and B used their individual supply resources to manage, transport, and store merchandise; now A and B, have a right to use all of each others supply resources to manage, transport, and store merchandise.

In order to share entirely a business organization, operating or seeking to operate super retail stores, would need to enter into a collaborative agreement with another business organization or other business organizations, operating or seeking to operate super retail stores, to share entirely resources used to supply super retail stores. An example follows. Corporation A, and Corporation B, enter into a joint-venture agreement, which discusses the following example terms: (1) that each party to the agreement will have the right to use the resources used to supply super retail stores of all parties to the agreement, (2) a governing body composed of representatives of A and B, yet under control of A and B individually, which determines which corporation has priority over which resources, (3) the amount of capital the parties will pay to each other to maintain the right of use.

Part one of the process involves a business organization, who operates or seeks to operate super retail stores, sharing entirely resources used to supply super retail stores with the resources used to supply super retail stores of another business organization or other business organizations, who operate or seek to operate super retail stores. An example follows. Corporations A and B create similar internal committees, who work cooperatively with each other to determine who has priority of given resources. For example the committees could determine that Corporation A has a need to use Corporation B's trucks and warehouses on given date to supply super retail stores belong to Corporation A with a shipment of merchandise that arrives on that date, and Corporation B would have priority on another date for a similar reason. Additionally, Corporations A and B acquire each others computer ordering, tracking, and managing software.

Part two of the process involves business organizations, who operate or seek to operate super retail stores supplying their super retail stores using the additional resources. An example follows. The following supplying takes place. Corporation A using the resources used to supply super retail stores of Corporation A and B supplies the merchandise Corporation A purchased to super retail stores belonging to Corporation A. Corporation B using the resources used to supply super retail stores of Corporation A and B supplies the merchandise Corporation B purchased to super retail stores belonging to Corporation B.

Further, the present invention relates to a method for supplying super retail store by a business organization operating or seeking to operate super retail stores, which comprises: (1) combine partially and sharing partially resources used to supply super retail stores with the resources used to supply super retail stores of another business organization or other business organizations, who operate(s) or seek (s) to operate super retail stores; (2) purchasing collectively some or all goods from common manufactures; (3) purchasing and supplying super retail stores using the additional resources. An example, discussed below, of three fictional corporations, Corporation A, Corporation B, and Corporation C, (hereinafter A, B, and C) who use the above mention process, shows the process provides a concrete and tangible change to the process of supplying super retails stores. Previously A, B, and C separately managed, transported, stored all merchandise for sale in their separate stores; now A, B, C or a subsidiary organization manages, transports, and stores some merchandise and A, B, and C separately supply the remaining merchandise to their stores. Additionally, A, B, and C, give each other the right to use some of each others supply resources to manage, transport, and store merchandise. Additionally, previously A, B, and C separately purchased merchandise from the same manufacturers; now A, B, and C purchase collectively some or all merchandise from common manufacturers.

In order to combine partially and share partially and purchase collectively, a business organization operating or seeking to operate super retail stores would need to enter into a collaborative agreement with another business organization or other business organizations, who operate(s) or seek(s) to operate super retail stores, to combine partially and to share partially resources used to supply super retail stores and to purchase collectively some or all goods from common manufactures. An example follows. Corporations A, B and C create and determine the management of a new general partnership called “X Corp.” Corporations A, B and C enter into a contract, which specifies the following example terms: (1) which resources used to supply super retail stores each party will transfer to X Corp in exchange for shares in X Corp, (2) the common manufactures from whom the parties will purchase goods from collectively, (3) the amount of yearly assets the parties will pay to maintain X Corp, (4) which stores, the parties will be contractually bound to allow X Corp to supply, (5) which merchandise, the parties will be contractually bound to allow X Corp to supply. Additionally, Corporation A, Corporation B, and Corporation C enter into a strategic alliance, which discusses the following example conditions: (1) which resources used to supply super retail stores, which party will have a right to use, such as Corporation C having a right to use some of Corporation B's warehouses, and Corporation A having a right to use Corporation C's trucks; (2) the amount of capital the parties will pay to each other to maintain the right of use.

Part one of the process involves a business organization, who operates or seeks to operate super retail stores, combining partially and sharing partially resources used to supply super retail stores with the resources used to supply super retail stores of another business organization or other business organizations, who operate(s) or seek (s) to operate super retail stores. An example follows. X Corp acquires the computer management, tracking, and ordering software of Corporations A, B, and C. X Corp acquires some of the trucks, personnel, warehouses, and contractual agreements relating to supplying the stores of Corporations A, B and C. X Corp owns, operates, controls, and assumes liability for the resources, which Corporation A, B, and C transferred to X Corp in exchange for shares in X Corp. Additionally, in the strategic alliance agreement, Corporation A acquires the right to use some warehouses belonging to Corporation B, and the right to use some trucks belonging to Corporation C. Corporation B acquires the right to use some warehouses belonging to Corporation C and some trucks belonging to Corporation A. Corporation C acquires the right to use some trucks belonging to Corporation B, and some warehouses belonging to Corporation A. Corporation A, B, and C, individually determine how their products will get from the manufacturers to their super retail stores using the newly available resources, and without the resources given away under the agreement. X Corp supplies some merchandise to super retail stores belonging to the different corporations A, B, and C. A, B, and C individually supply their own stores with some merchandise using the right of use acquired under the strategic alliance agreement.

Part two of the process involves business organizations, who operate or seek to operate super retail stores, purchasing collectively some or all goods from common manufactures. An example follows. In the strategic alliance agreement Corporations A, B, and C agree: A will purchase all the hardware sold to Corporations A, B, and C by common manufacturers, B will purchase all the garden products sold to Corporations A, B, and C by common manufacturers, and C will purchase all the groceries sold to Corporations A, B, and C by common manufacturers, and X Corp will purchase all the tables sold to Corporations A, B, and C by common manufacturers. Corporation A purchases all the hardware sold to Corporations A, B, and C by common manufacturers. Corporation B purchases all the garden products sold to Corporations A, B, and C by common manufacturers. C purchases all the groceries sold to Corporations A, B, and C by common manufacturers. X Corp purchases all the tables sold to Corporations A, B, and C by common manufacturers.

Part three of the process involves business organizations, who operate super retail stores purchasing and supplying their super retail stores using the additional resources. An example follows. The following purchasing takes place. Corporation A purchases all the hardware. Corporation B purchases all the garden products. Corporation C purchases all the groceries. X Corp purchases all the tables. The following supplying takes place. X Corp, owned by Corporations A, B, and C, uses the resources used to supply super retail stores, which Corporations A, B, and C, transferred to it to supply super retail stores belonging to Corporations A, B, and C. Corporation A supplies super retail stores belonging to Corporation A using Corporation A's resources used to supply super retail stores, which includes using some warehouses belonging to Corporation B and some trucks belonging to Corporation C. Corporation B supplies super retail stores belonging to Corporation B using Corporation B's resources used to supply super retail stores, which includes some warehouses belonging to Corporation C and some trucks belonging to Corporation A. Corporation C supplies super retail stores belonging to Corporation C using Corporation C's resources used to supply super retail stores, which includes some trucks belonging to Corporation B and some warehouses belonging to Corporation A. X Corp orders, manages, tracks, transports goods from the manufacturer to the super retail stores. Each Corporation supplies its own stores, with the additional resources acquired through the strategic alliance and using X Corp to supply some merchandise to some of the stores.

Further, the present invention relates to a method for supplying a super retail store by a business organization operating or seeking to operate super retail stores, which comprises: (1) combining partially and sharing partially resources used to supply super retail stores with the resources used to supply super retail stores of another business organization or other business organizations, who operate(s) or seek (s) to operate super retail stores; (2) supplying super retail stores using the additional resources. An example, discussed below, of three fictional corporations, Corporation A, Corporation B, and Corporation C, (hereinafter A, B, and C) who use the above mention process, shows the process provides a concrete and tangible change to the process of supplying super retails stores. Previously A, B, and C separately managed, transported, stored all merchandise for sale in their separate stores; now A, B, C or a subsidiary organization manages, transports, and stores some merchandise and A, B, and C separately supply the remaining merchandise to their stores. Additionally, A, B, and C, give each other the right to use some of each others supply resources to manage, transport, and store merchandise.

In order to combine partially and share partially a business organization, operating or seeking to operate super retail stores, would need to enter into a collaborative agreement with another business organization or other business organizations, operating or seeking to operate super retail stores, to combine partially and share partially resources used to supply super retail stores. An example follows. Corporations A, B and C create and determine the management of a new general partnership called “X Corp.” Corporations A, B and C enter into a contract, which specifies the following example terms: (1) which resources used to supply super retail stores each party will transfer to X Corp in exchange for shares in X Corp, (2) the amount of yearly assets the parties will pay to maintain X Corp, (3) which stores, the parties will be contractually bound to allow X Corp to supply, (4) which merchandise, the parties will be contractually bound to allow X Corp to supply. Additionally, Corporation A, Corporation B, and Corporation C enter into a strategic alliance, which discusses the following example conditions: (1) which resources used to supply super retail stores, which party will have a right to use, such as Corporation C having a right to use some of Corporation B's warehouses, and Corporation A having a right to use Corporation C's trucks; (2) the amount of capital the parties will pay to each other to maintain the right of use.

Part one of the process involves a business organization, who operates or seeks to operate super retail stores, combining partially and sharing partially resources used to supply super retail stores with the resources used to supply super retail stores of another business organization or other business organizations, who operate or seek to operate super retail stores. An example follows. X Corp acquires the computer management, tracking, and ordering software of Corporations A, B, and C. X Corp acquires some of the trucks, personnel, warehouses, and contractual agreements relating to supplying the stores of Corporations A, B and C. X Corp owns, operates, controls, and assumes liability for the resources, which Corporation A, B, and C transferred to X Corp in exchange for shares in X Corp. Additionally, in the strategic alliance agreement, Corporation A acquires the right to use some warehouses belonging to Corporation B, and the right to use some trucks belonging to Corporation C. Corporation B acquires the right to use some warehouses belonging to Corporation C and some trucks belonging to Corporation A. Corporation C acquires the right to use some trucks belonging to Corporation B, and some warehouses belonging to Corporation A. Corporation A, B, and C, individually determines how their products will get from the manufacturers to their super retail stores using the newly available resources, and without the resources given away under the agreement.

Part two of the process involves business organizations, who operate or seek to operate super retail stores supplying their super retail stores using the additional resources. An example follows. The following supplying takes place. X Corp, owned by Corporations A, B, and C, uses the resources used to supply super retail stores, which Corporations A, B, and C, transferred to it to supply super retail stores belonging to Corporations A, B, and C. Corporation A supplies super retail stores belonging to Corporation A using Corporation A's resources used to supply super retail stores, which includes using some warehouses belonging to Corporation B and some trucks belonging to Corporation C. Corporation B supplies super retail stores belonging to Corporation B using Corporation B's resources used to supply super retail stores, which includes some warehouses belonging to Corporation C and some trucks belonging to Corporation A. Corporation C supplies super retail stores belonging to Corporation C using Corporation C's resources used to supply super retail stores, which includes some trucks belonging to Corporation B and some warehouses belonging to Corporation A. X Corp orders, manages, tracks, transports goods from the manufacturer to the super retail stores. Each Corporation supplies its own stores, with the additional resources acquired through the strategic alliance and X Corp to supply some merchandise to some of the stores.

Further, the present invention relates to a method for supplying super retail store by a business organization operating or seeking to operate super retail stores, which comprises: (1) combine partially and sharing entirely resources used to supply super retail stores with the resources used to supply super retail stores of another business organization or other business organizations, who operate(s) or seek (s) to operate super retail stores; (2) purchasing collectively some or all goods from common manufactures; (3) purchasing and supplying super retail stores using the additional resources. An example, discussed below, of three fictional corporations, Corporation A, Corporation B, and Corporation C, (hereinafter A, B, and C) who use the above mention process, shows the process provides a concrete and tangible change to the process of supplying super retails stores. Essentially, Previously A, B, and C separately managed, transported, stored their merchandise; now A, B, C or a subsidiary organization manages, transports, and stores some merchandise and A, B, and C individually supply the remaining merchandise to their super retail stores. Additionally, A, B, and C, give each other the right to use all of each others resources used to super retail stores to manage, transport, and store merchandise. Additionally, previously A, B, and C separately purchased merchandise from the same manufacturers; now A, B, and C purchase collectively some or all merchandise from common manufacturers.

In order to combine partially and share entirely and purchase collectively, a business organization operating or seeking to operate super retail stores would need to enter into a collaborative agreement with another business organization or other business organizations, who operate(s) or seek(s) to operate super retail stores, to combine partially and to share entirely resources used to supply super retail stores and to purchase collectively some or all goods from common manufactures. An example follows. Corporations A, B and C create and determine the management of a new general partnership called “X Corp.” Corporations A, B and C enter into a contract, which specifies the following example terms: (1) which resources used to supply super retail stores each party will transfer to X Corp in exchange for shares in X Corp, (2) the common manufactures from whom the parties will purchase goods from collectively, (3) the amount of yearly assets the parties will pay to maintain X Corp, (4) which stores, the parties will be contractually bound to allow X Corp to supply, (5) which merchandise, the parties will be contractually bound to allow X Corp to supply. Additionally, Corporation A, B, and C enter into a joint-venture agreement, which discusses the following example terms: (1) that each party to the agreement will have the right to use the resources used to supply super retail stores of all other parties to the agreement, (2) X Corp determines which corporation has priority over which resources, (3) the amount of capital the parties will pay to each other to maintain the right of use.

Part one of the process involves a business organization, who operates or seeks to operate super retail stores, combining partially and sharing entirely resources used to supply super retail stores with the resources used to supply super retail stores of another business organization or other business organizations, who operate(s) or seek (s) to operate super retail stores. An example follows. X Corp acquires the computer management, tracking, and ordering software of Corporations A, B, and C. X Corp acquires some of the trucks, personnel, warehouses, and contractual agreements relating to supplying the stores of Corporations A, B and C. X Corp owns, operates, controls, and assumes liability for the resources, which Corporation A, B, and C transferred to X Corp in exchange for shares in X Corp. Additionally, Corporations A, B, and C create similar internal committees, who work cooperatively with X Corp to ensure the efficient supply of merchandise to super retail stores.

Part two of the process involves business organizations, who operate or seek to operate super retail stores, purchasing collectively some or all goods from common manufactures. An example follows. Corporations A, B, and C agree: A will purchase all the hardware sold to Corporations A, B, and C by common manufacturers, B will purchase all the garden products sold to Corporations A, B, and C by common manufacturers, and C will purchase all the groceries sold to Corporations A, B, and C by common manufacturers, and X Corp will purchase all the tables sold to Corporations A, B, and C by common manufacturers. Corporation A purchases all the hardware sold to Corporations A, B, and C by common manufacturers. Corporation B purchases all the garden products sold to Corporations A, B, and C by common manufacturers. C purchases all the groceries sold to Corporations A, B, and C by common manufacturers. X Corp purchases all the tables sold to Corporations A, B, and C by common manufacturers.

Part three of the process involves business organizations, who operate super retail stores purchasing and supplying their super retail stores using the additional resources. An example follows. The following purchasing takes place. Corporation A purchases all the hardware. Corporation B purchases all the garden products. Corporation C purchases all the groceries. X Corp purchases all the tables. The following supplying takes place. X Corp, owned by Corporations A, B, and C, uses the resources used to supply super retail stores, which Corporations A, B, and C, transferred to it in order to supply super retail stores belonging to Corporations A, B, and C. X Corp orders, manages, tracks, transports goods from the manufacturer to the super retail store. Additionally, Corporation A using the resources used to supply super retail stores of Corporation A, B, and C supplies the merchandise Corporation A purchased and its share of the merchandise, which was purchased for the collective use, to super retail stores belonging to Corporation A. Corporation B using the resources used to supply super retail stores of Corporation A, B, and C supplies the merchandise Corporation B purchased and its share of the merchandise, which was purchased for the collective use, to super retail stores belonging to Corporation B. Corporation C using the resources used to supply super retail stores of Corporation A, B, and C supplies the merchandise Corporation C purchased and its share of the merchandise, which was purchased for the collective use, to super retail stores belonging to Corporation C. Each Corporation supplies its own stores, with the additional resources acquired through the joint venture agreement and using X Corp to supply some merchandise to some of the stores.

Further, the present invention relates to a method for supplying super retail store by a business organization operating or seeking to operate super retail stores, which comprises: (1) combine partially and sharing entirely resources used to supply super retail stores with the resources used to supply super retail stores of another business organization or other business organizations, who operate(s) or seek (s) to operate super retail stores; (2) purchasing and supplying super retail stores using the additional resources. An example, discussed below, of three fictional corporations, Corporation A, Corporation B, and Corporation C, (hereinafter A, B, and C) who use the above mention process, shows the process provides a concrete and tangible change to the process of supplying super retails stores. Essentially, Previously A, B, and C separately managed, transported, stored their merchandise; now A, B, C or a subsidiary organization manages, transports, and stores some merchandise and A, B, and C individually supply the remaining merchandise to their super retail stores. Additionally, A, B, and C, give each other the right to use all of each others resources used to super retail stores to manage, transport, and store merchandise.

In order to combine partially and share entirely a business organization, operating or seeking to operate super retail stores, would need to enter into a collaborative agreement with another business organization or other business organizations, operating or seeking to operate super retail stores, to combine partially and share entirely resources used to supply super retail stores. An example follows. Corporations A, B and C create and determine the management of a new general partnership called “X Corp.” Corporations A, B and C enter into a contract, which specifies the following example terms: (1) which resources used to supply super retail stores each party will transfer to X Corp in exchange for shares in X Corp, (2) the common manufactures from whom the parties will purchase goods from collectively, (3) the amount of yearly assets the parties will pay to maintain X Corp, (4) which stores, the parties will be contractually bound to allow X Corp to supply, (5) which merchandise, the parties will be contractually bound to allow X Corp to supply. Additionally, Corporation A, B, and C enter into a joint-venture agreement, which discusses the following example terms: (1) that each party to the agreement will have the right to use the resources used to supply super retail stores of all parties to the agreement, (2) X Corp determines which corporation has priority over which resources, (3) the amount of capital the parties will pay to each other to maintain the right of use.

Part one of the process involves a business organization, who operates or seeks to operate super retail stores, combining partially and sharing entirely resources used to supply super retail stores with the resources used to supply super retail stores of another business organization or other business organizations, who operate(s) or seek (s) to operate super retail stores. An example follows. X Corp acquires the computer management, tracking, and ordering software of Corporations A, B, and C. X Corp acquires some of the trucks, personnel, warehouses, and contractual agreements relating to supplying the stores of Corporations A, B and C. X Corp owns, operates, controls, and assumes liability for the resources, which Corporation A, B, and C transferred to X Corp in exchange for shares in X Corp. Additionally, Corporations A, B, and C create similar internal committees, who work cooperatively with X Corp to determine who has priority of the given resources remaining in control of A, B, and C, individually.

Part two of the process involves business organizations, who operate or seek to operate super retail stores supplying their super retail stores using the additional resources. An example follows. The following supplying takes place. X Corp, owned by Corporations A, B, and C, uses the resources used to supply super retail stores, which Corporations A, B, and C, transferred to it in order to supply super retail stores belonging to Corporations A, B, and C. X Corp orders, manages, tracks, transports goods from the manufacturer to the super retail store. Additionally, Corporation A using the resources used to supply super retail stores of Corporation A, B, and C supplies the merchandise Corporation A purchased and its share of the merchandise, which was purchased for the collective use, to super retail stores belonging to Corporation A. Corporation B using the resources used to supply super retail stores of Corporation A, B, and C supplies the merchandise Corporation B purchased and its share of the merchandise, which was purchased for the collective use, to super retail stores belonging to Corporation B. Corporation C using the resources used to supply super retail stores of Corporation A, B, and C supplies the merchandise Corporation C purchased and its share of the merchandise, which was purchased for the collective use, to super retail stores belonging to Corporation C. Each Corporation supplies its own stores, with the additional resources acquired through the joint venture agreement and using X Corp to supply some merchandise to some of the stores.

### SUMMARY OF THE INVENTION OPERATION

Combining means there is an actual transfer of ownership of resources used to supply super retail stores. There are three major ways of combining: combining through a contractual agreement, through the creation of a subsidiary organization, or through the creation of a quasi-subsidiary organization. An example of combining through a contractual agreement would be Corporation A enters into a contract to transfer all of its resources used to supply super retail stores to Corporation B in exchange for shares in Corporation B. Corporation B would have ownership of the resources used to supply super retail stores which Corporation A transferred to it, yet be obligated to supply stores for Corporation A.

An example of combining through the creation of a subsidiary organization would be Corporation A, Corporation B, and Corporation C create and determine the management of a subsidiary corporation in the form of a general partnership. Corporations A, B, and C transfer their separate resources used to supply super retail stores to the subsidiary general partnership in exchange for shares in the partnership. The general partnership owns the resources Corporations A, Corporation B, and Corporation C transferred to it and has the obligation to supply super retail stores belonging to the different corporations A, B, and C.

An example of combing through the creation of a quasi-subsidiary organization would be Corporation A enters into an agreement with Corporation B creating a joint venture partnership or corporation. Corporations A and Corporation B assign the joint venture partnership their resources used to supply super retail stores. The joint venture partnership has ownership of the resources used to supply super retail stores of both Corporation A and Corporation B.

Sharing means a retailer gives another retailer or other retailers a right to use their resources. There are three major ways of sharing: sharing through a contractual agreement, sharing through a joint venture agreement, and sharing through a strategic alliance agreement. An example of sharing through a contractual agreement would be Corporation A agrees to allow Corporation B to use some of Corporation A's resources used to supply super retail stores, such as trucks, in consideration for the right to use some of Corporation B's resources used to supply super retail stores, such as warehouse space. Examples of sharing through a joint venture agreement and sharing through a strategic alliance agreement are similar to the example of sharing through a contractual agreement except the parties specify they are entering into a joint venture or strategic alliance and follow the business obligations associated with those specific agreements.

Many retailers purchase the same goods from the same manufacturers or distributors. Purchasing collectively as a part of the business process allows the retailers to buy in larger volume and get a consequently get lower prices for the same goods. Since Wal-Mart has an overwhelming domination of the super retail market, other retailers could use this part of the process to remain competitive.

### SUMMARY OF THE INVENTION: PURPOSE

The purpose of this invention is to provide a method of supplying stores through retailers restructuring existing resources to allow for use of more resources and consequently making them more competitive. In order to be able to combine and/or share, partially or entirely resources used to supply stores, retailer corporations would need to enter into agreements with each other. Retail corporations enter into many contractual agreements involving supplying their stores, such as with suppliers, distributors, or trucking corporations. This patent presents the business processes of retailers entering into agreements with other retailers and making larger the total amount of resources, which are used to purchase and/or supply their individual super retail stores. The business process herein mentioned is not a merger it is the combination of retailers' resources used to supply super retail stores or the sharing of retailers' resources used to supply super retail stores. A merger is the combination of the entire business organizations into each other. In this patent, the ownership of the super retail stores themselves remains with the individual retailer. While assets are combined under several of the processes, the corporations themselves do not merge and ownership of the super retail stores remains with the different corporations.

The business processes herein mentioned are not ideas for new business ventures, rather the processes are methods of structuring resources with other retailers to make more efficient use of pre-existing resources. Since retailers regularly enter into agreements to supply their stores, since the process presents a method for restructuring pre-existing resources, and since the overall purpose, to supply super retail stores, does not change, these methods are not ideas for new business ventures. This patent presents a concrete, tangible, and more profitable method of restructuring existing resources to achieve the same objective-purchasing goods and supplying stores.

### DESCRIPTION OF DRAWINGS

The invention contains the following drawings: FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14.

FIG. 1: Present with Three Example Corporations:

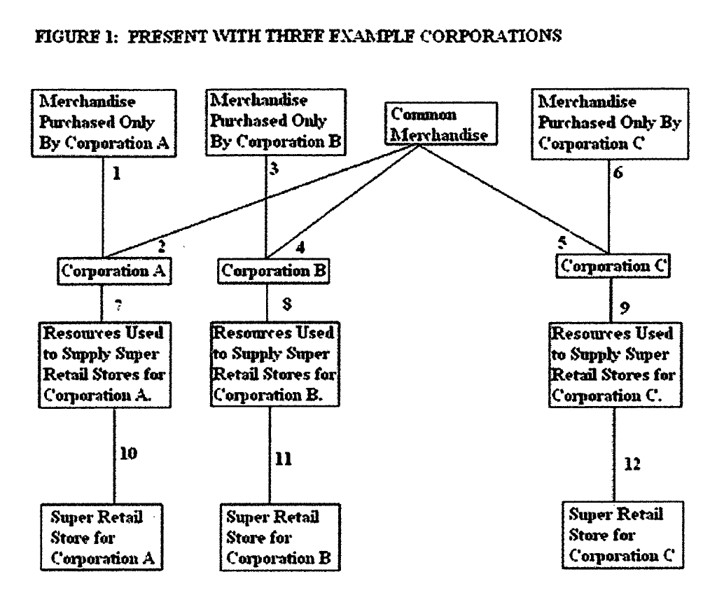

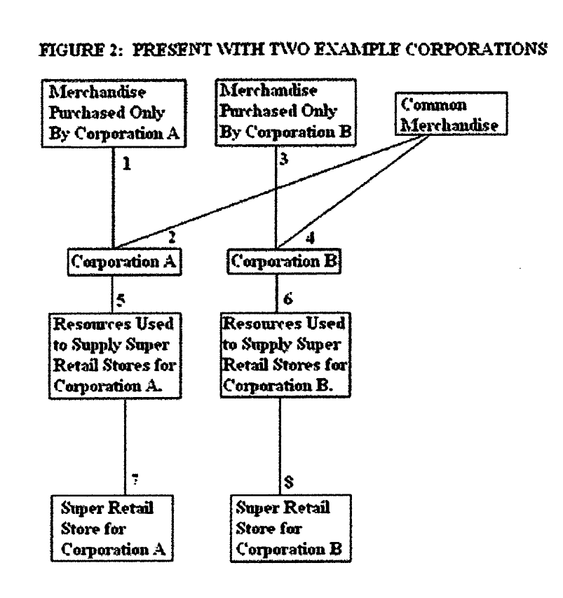

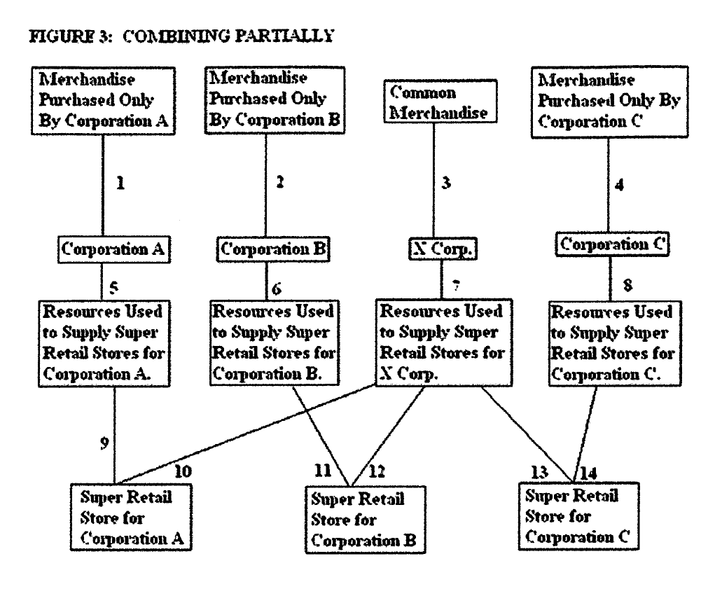

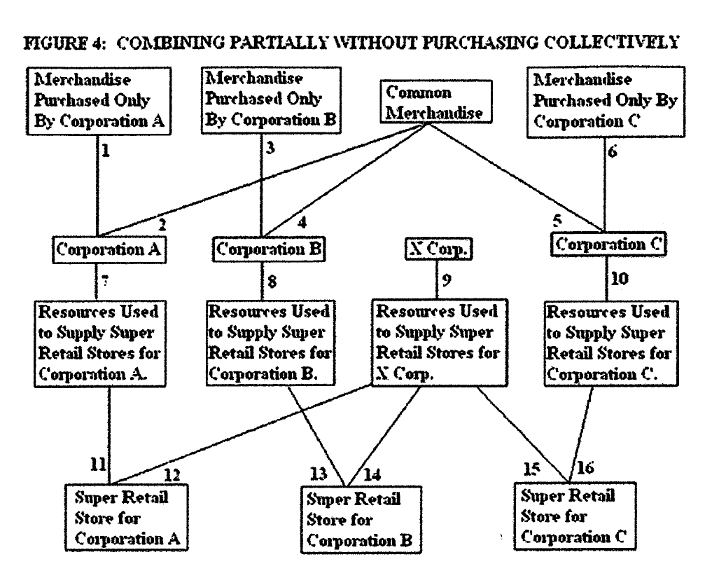

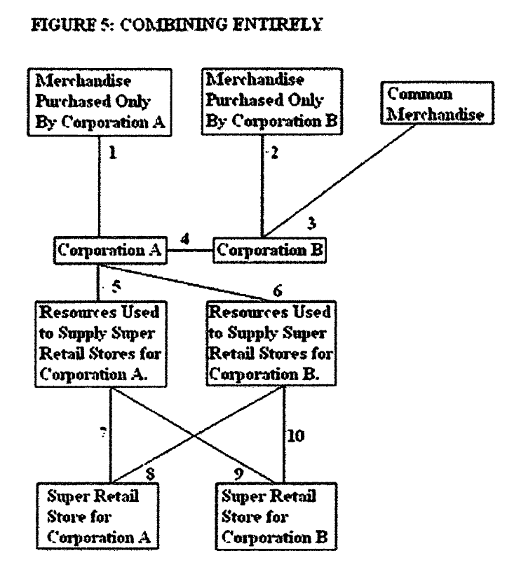

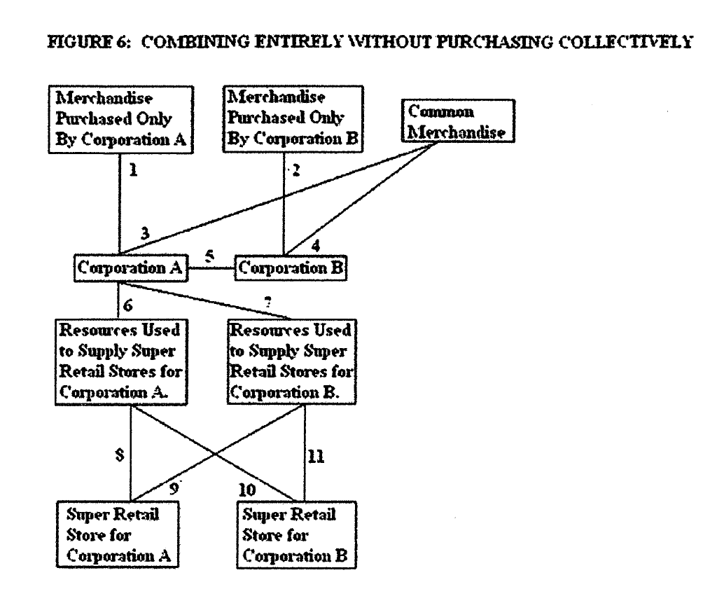

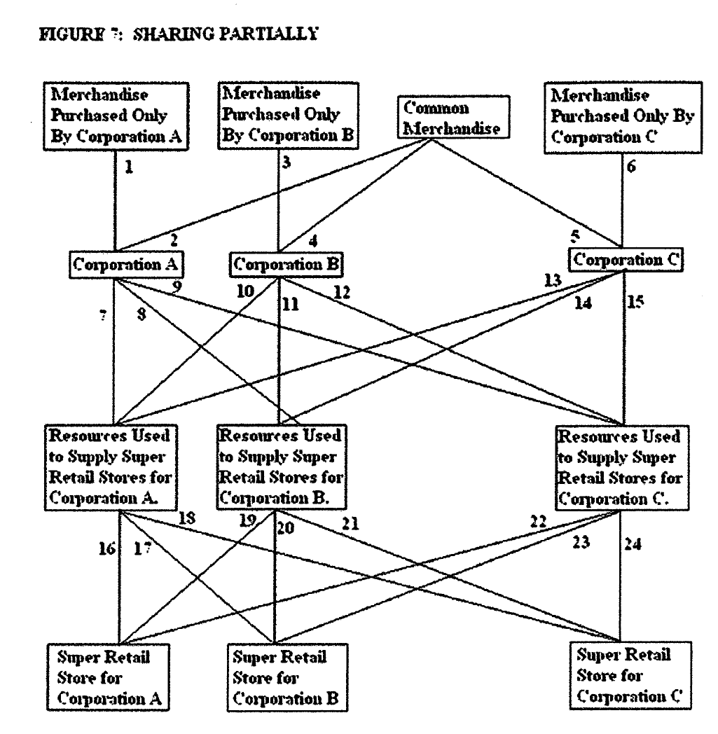

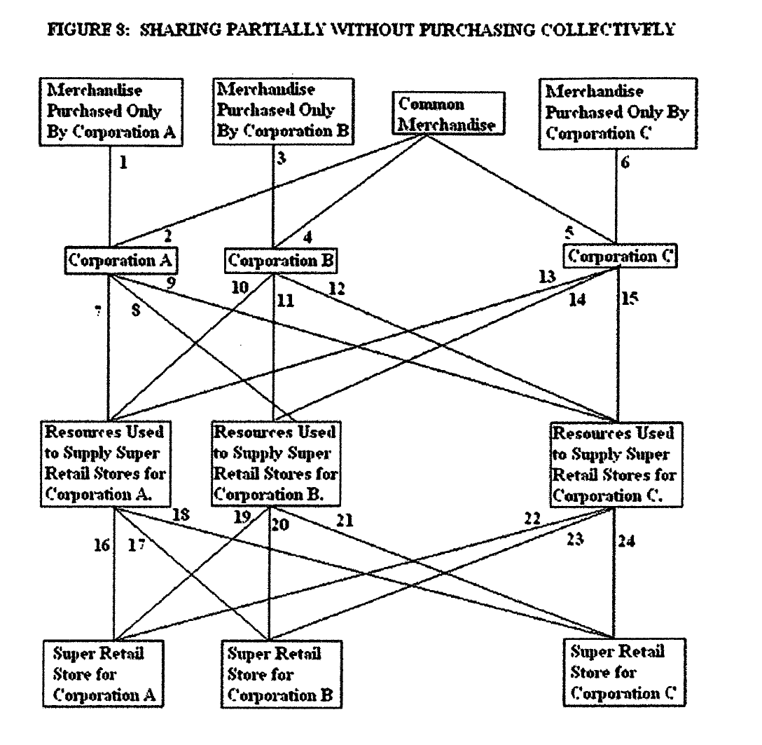

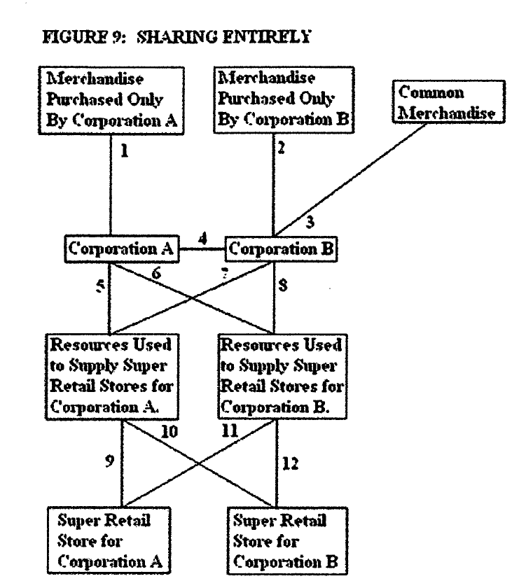

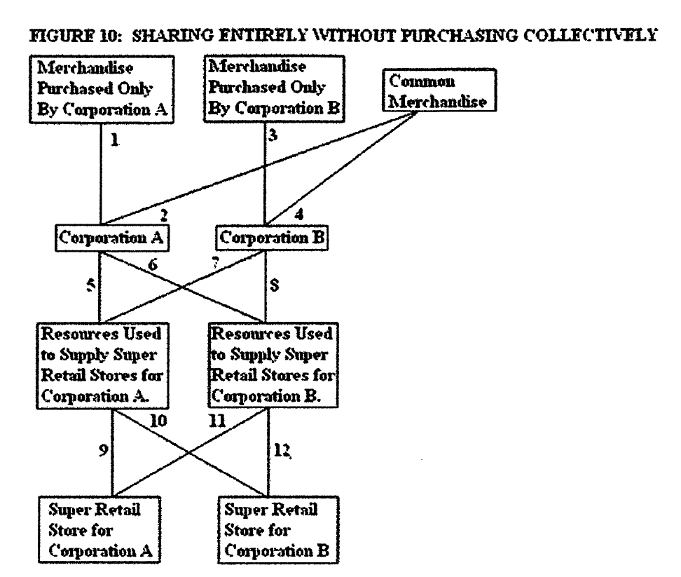

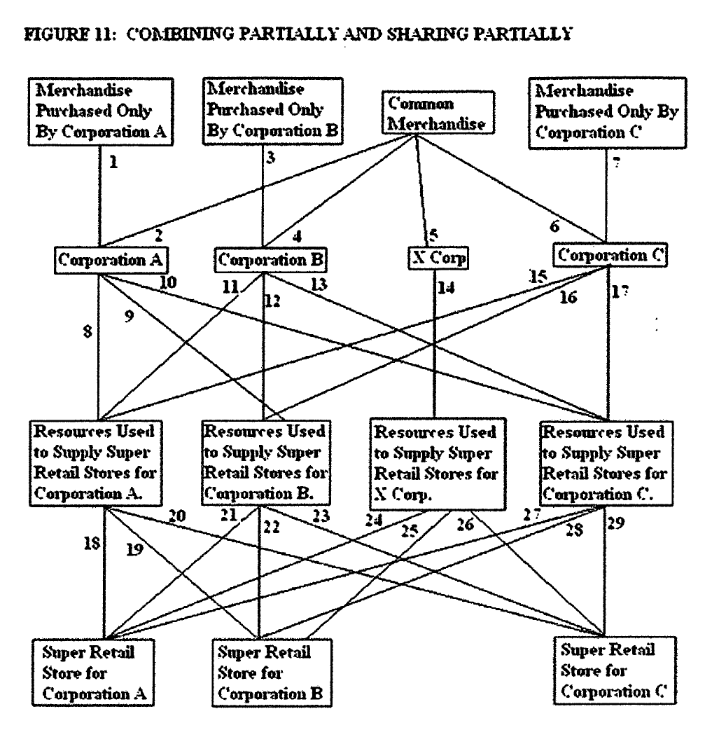

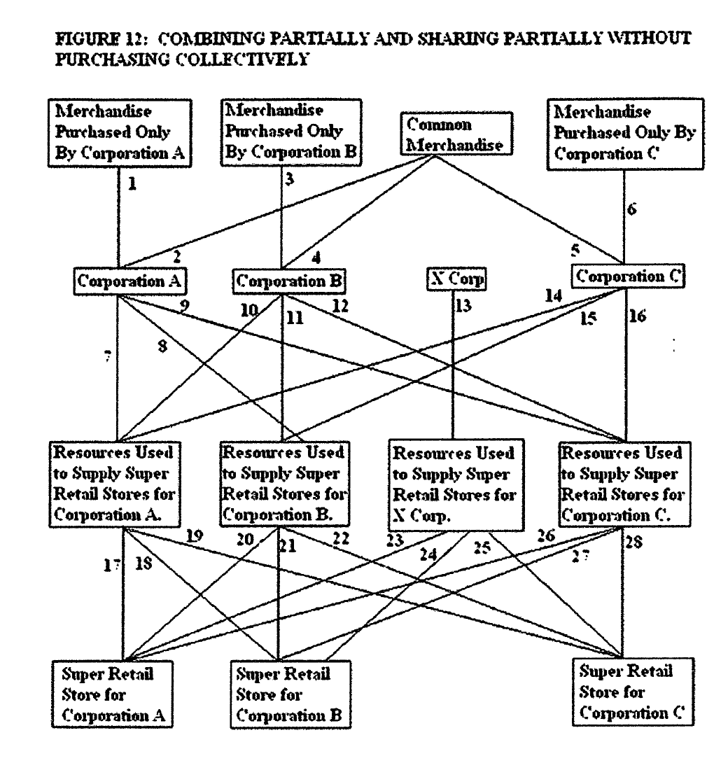

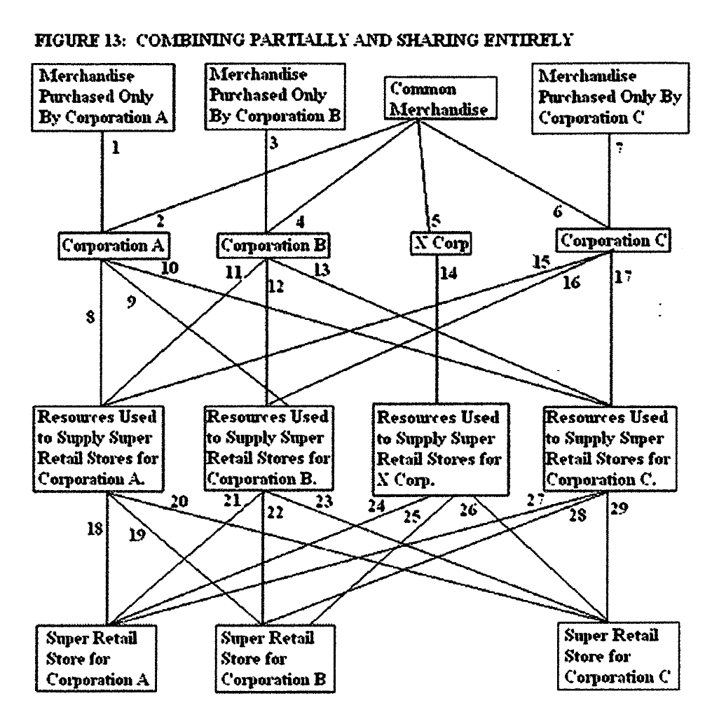

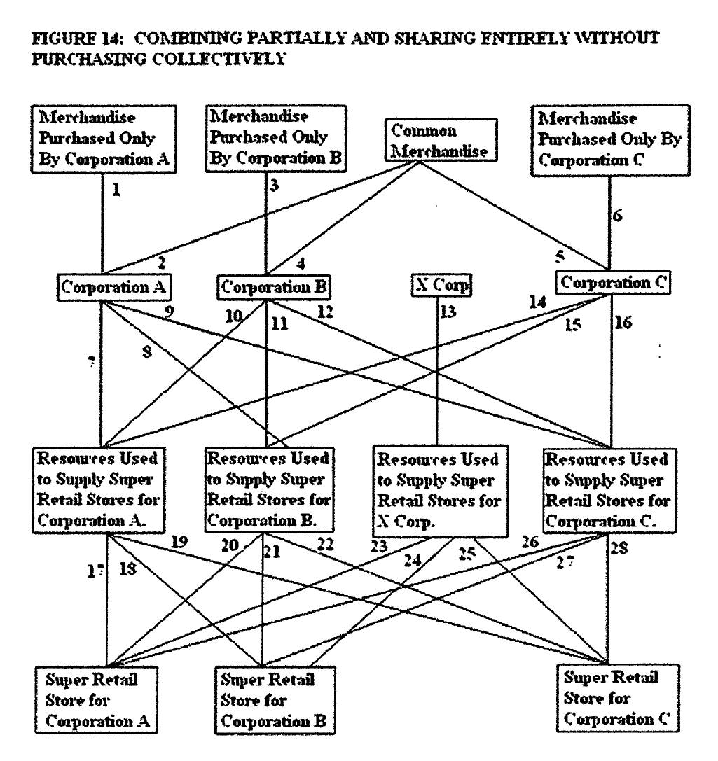

Corporation A purchases merchandise from manufacturers or distributors to eventually sell in Corporation A's super retail stores.

Corporations B and C do not purchase from these manufacturers.

Corporation A purchases merchandise from manufactures or distributors to eventually sell in Corporation A's super retail stores.

Corporations B and C purchase from these manufacturers, as well.

Corporation B purchases merchandise from manufacturers or distributors to eventually sell in Corporation B's super retail stores.

Corporations A and C do not purchase from these manufacturers.

Corporation B purchases merchandise from manufactures or distributors to eventually sell in Corporation B's super retail stores.

Corporations A and C purchase from these manufacturers as well.

Corporation C purchases merchandise from manufacturers or distributors to eventually sell in Corporation C's super retail stores.

Corporations A and B do not purchase from these manufacturers.

Corporation C purchases merchandise from manufactures or distributors to eventually sell in Corporation C's super retail stores.

Corporations A and B purchase from these manufacturers, as well.

Corporation A owns and uses resources used to supply super retail Stores for Corporation A.

Corporation B owns and uses resources used to supply super retail stores for Corporation B.

Corporation C owns and uses resources used to supply super retail stores for Corporation C.

Corporation A uses the resources used to supply super retail stores for Corporation A to supply super retail stores belonging to Corporation A with all merchandise.

Corporation B uses the resources used to supply super retail stores for Corporation B to supply super retail stores belonging to Corporation B with all merchandise.

Corporation C uses the resources used to supply super retail stores for Corporation C to supply super retail stores belonging to Corporation C with all merchandise.

FIG. 2: Present with Two Example Corporations:

Corporation A purchases merchandise from manufacturers or distributors to eventually sell in Corporation A's super retail stores.

Corporations B does not purchase from these manufacturers.

Corporation A purchases merchandise from manufactures or distributors to eventually sell in Corporation A's super retail stores.

Corporations B purchases from these manufacturers, as well.

Corporation B purchases merchandise from manufacturers or distributors to eventually sell in Corporation B's super retail stores.

Corporations A does not purchase from these manufacturers.

Corporation B purchases merchandise from manufactures or distributors to eventually sell in Corporation B's super retail stores.

Corporations A purchases from these manufacturers, as well.

Corporation A owns and uses resources used to supply super retail Stores for Corporation A.

Corporation B owns and uses resources used to supply super retail stores for Corporation B.

Corporation A uses the resources used to supply super retail stores for Corporation A to supply super retail stores belonging to Corporation A with all merchandise.

Corporation B uses the resources used to supply super retail stores for Corporation B to supply super retail stores belonging to Corporation B with all merchandise.

FIG. 3: Combining Partially

Corporation A purchases merchandise to sell in stores belonging to Corporation A.

Corporation B purchases merchandise to sell in stores belonging to Corporation B.

X Corp purchases agreed upon merchandise from common manufactures to sell in stores belonging to Corporation A, B, C.

Corporation A purchases merchandise to sell in stores belonging to Corporation C.

Corporation A owns and uses resources used to supply super retail Stores for Corporation A.

Corporation B owns and uses resources used to supply super retail stores for Corporation B.

X Corp owns and uses resources used to supply super retail stores for X Corp.

Corporation C owns and uses resources used to supply super retail stores for Corporation C.

Corporation A uses the resources used to supply super retail stores for Corporation A to supply super retail Stores belonging to Corporation A with some merchandise.

X Corp uses the resources used to supply super retail stores for X Corp to supply super retail stores belonging to Corporation A with some merchandise.

Corporation B uses the resources used to supply super retail stores for Corporation B to supply super retail stores belonging to Corporation B with some merchandise.

X Corp uses the resources used to supply super retail stores for X Corp to supply super retail stores belonging to Corporation B with some merchandise.

Corporation C uses the resources used to supply super retail stores for Corporation C to supply super retail stores belonging to Corporation C with some merchandise.

X Corp uses the resources used to supply super retail stores for X Corp to supply super retail stores belonging to Corporation C with some merchandise.

FIG. 4: Combining Partially without Purchasing Collectively:

Corporation A purchases merchandise from manufacturers or distributors to eventually sell in Corporation A's super retail stores.

Corporations B and C do not purchase from these manufacturers.

Corporation A purchases merchandise from manufactures or distributors to eventually sell in Corporation A's super retail stores.

Corporations B and C purchase from these manufacturers, as well.

Corporation B purchases merchandise from manufacturers or distributors to eventually sell in Corporation B's super retail stores.

Corporations A and C do not purchase from these manufacturers.

Corporation B purchases merchandise from manufactures or distributors to eventually sell in Corporation B's super retail stores.

Corporations A and C purchase from these manufacturers as well.

Corporation C purchases merchandise from manufacturers or distributors to eventually sell in Corporation C's super retail stores.

Corporations A and B do not purchase from these manufacturers.

Corporation C purchases merchandise from manufactures or distributors to eventually sell in Corporation C's super retail stores.

Corporations A and B purchase from these manufacturers, as well.

Corporation A owns and uses resources used to supply super retail Stores for Corporation A.

Corporation B owns and uses resources used to supply super retail stores for Corporation B.

X Corp owns and uses resources used to supply super retail stores for X Corp.

Corporation C owns and uses resources used to supply super retail stores for Corporation C.

Corporation A uses the resources used to supply super retail stores for Corporation A to supply super retail Stores belonging to Corporation A with some merchandise.

X Corp uses the resources used to supply super retail stores for X Corp to supply super retail stores belonging to Corporation A with some merchandise.

Corporation B uses the resources used to supply super retail stores for Corporation B to supply super retail stores belonging to Corporation B with some merchandise.

X Corp uses the resources used to supply super retail stores for X Corp to supply super retail stores belonging to Corporation B with some merchandise.

Corporation C uses the resources used to supply super retail stores for Corporation C to supply super retail stores belonging to Corporation C with some merchandise.

X Corp uses the resources used to supply super retail stores for X Corp to supply super retail stores belonging to Corporation C with some merchandise.

FIG. 5: Combining Entirely:

Corporation A purchases merchandise from manufacturers or distributors to eventually sell in Corporation A's super retail stores.

Corporations B does not purchase from these manufacturers.

Corporation B purchases merchandise from manufacturers or distributors to eventually sell in Corporation B's super retail stores.

Corporations A does not purchase from these manufacturers.

Corporation B purchases agreed upon merchandise from common manufactures to sell in stores belonging to the different corporations, A and B.

Corporation A acquires the merchandise purchased from common manufacturers and the merchandise purchased only by Corporation B.

Corporation A owns and uses resources used to supply super retail Stores for Corporation A.

Corporation A owns and uses resources used to supply super retail stores for Corporation B.

Corporation A uses the resources used to supply super retail stores for Corporation A to supply super retail Stores belonging to Corporation A with some merchandise.

Corporation A uses the resources used to supply super retail stores for Corporation B to supply super retail Stores belonging to Corporation A with some merchandise.

Corporation A uses the resources used to supply super retail stores for Corporation A to supply super retail Stores belonging to Corporation B with some merchandise.

Corporation A uses the resources used to supply super retail stores for Corporation B to supply super retail Stores belonging to Corporation B with some merchandise.

FIG. 6: Combining Entirely without Purchasing Collectively:

Corporation A purchases merchandise from manufacturers or distributors to eventually sell in Corporation A's super retail stores.

Corporations B does not purchase from these manufacturers.

Corporation A purchases merchandise from manufactures or distributors to eventually sell in Corporation A's super retail stores.

Corporations B purchases from these manufacturers, as well.

Corporation B purchases merchandise from manufacturers or distributors to eventually sell in Corporation B's super retail stores.

Corporations A does not purchase from these manufacturers.

Corporation B purchases merchandise from manufactures or distributors to eventually sell in Corporation B's super retail stores.

Corporations A purchases from these manufacturers, as well.

Corporation A acquires the merchandise purchased by Corporation B.

Corporation A owns and uses resources used to supply super retail Stores for Corporation A.

Corporation A owns and uses resources used to supply super retail stores for Corporation B.

Corporation A uses the resources used to supply super retail stores for Corporation A to supply super retail Stores belonging to Corporation A with some merchandise.

Corporation A uses the resources used to supply super retail stores for Corporation B to supply super retail Stores belonging to Corporation A with some merchandise.

Corporation A uses the resources used to supply super retail stores for Corporation A to supply super retail Stores belonging to Corporation B with some merchandise.

Corporation A uses the resources used to supply super retail stores for Corporation B to supply super retail Stores belonging to Corporation B with some merchandise.

FIG. 7: Sharing Partially

Corporation A purchases merchandise from manufacturers or distributors to eventually sell in Corporation A's super retail stores.

Corporations B and C do not purchase from these manufacturers.

Corporation A purchases agreed upon merchandise from common manufactures to sell in stores belonging to the different corporations, A, B, C.

Corporation B purchases merchandise from manufacturers or distributors to eventually sell in Corporation B's super retail stores.

Corporations A and C do not purchase from these manufacturers.

Corporation B purchases agreed upon merchandise from common manufactures to sell in stores belonging to the different corporations, A, B, and C.

Corporation C purchases agreed upon merchandise from common manufactures to sell in stores belonging to the different corporations, A, B, C.

Corporation C purchases merchandise from manufacturers or distributors to eventually sell in Corporation C's super retail stores.

Corporations A and B do not purchase from these manufacturers.

Corporation A owns and uses resources used to supply super retail stores for Corporation A.

Corporation A has a right to use some resources used to supply super retail stores for Corporation B.

Corporation A has a right to use some resources used to supply super retail stores for Corporation C.

Corporation B has a right to use some resources used to supply super retail stores for Corporation A.

Corporation B owns and uses resources used to supply super retail stores for Corporation B.

Corporation B has a right to use some resources used to supply super retail stores for Corporation C.

Corporation C has a right to use some resources used to supply super retail stores for Corporation A.

Corporation C has a right to use some resources used to supply super retail stores for Corporation B.

Corporation C owns and uses resources used to supply super retail stores for Corporation C.

Corporation A uses the resources used to supply super retail stores for Corporation A to supply super retail stores belonging to Corporation A with some merchandise.

Corporation B uses the resources used to supply super retail stores for Corporation A to supply super retail stores belonging to Corporation B with some merchandise.

Corporation C uses the resources used to supply super retail stores for Corporation A to supply super retail stores belonging to Corporation C with some merchandise.

Corporation A uses the resources used to supply super retail stores for Corporation B to supply super retail stores belonging to Corporation A with some merchandise.

Corporation B uses the resources used to supply super retail stores for Corporation B to supply super retail stores belonging to Corporation B with some merchandise.

Corporation C uses the resources used to supply super retail stores for Corporation B to supply super retail stores belonging to Corporation C with some merchandise.

Corporation A uses the resources used to supply super retail stores for Corporation C to supply super retail stores belonging to Corporation A with some merchandise.

Corporation B uses the resources used to supply super retail stores for Corporation C to supply super retail stores belonging to Corporation B with some merchandise.

Corporation C uses the resources used to supply super retail stores for Corporation C to supply super retail stores belonging to Corporation C with some merchandise.

FIG. 8: Sharing Partially without Purchasing Collectively

Corporation A purchases merchandise from manufacturers or distributors to eventually sell in Corporation A's super retail stores.

Corporations B and C do not purchase from these manufacturers.

Corporation A purchases merchandise from manufactures or distributors to eventually sell in Corporation A's super retail stores.

Corporations B and C purchase from these manufacturers, as well.

Corporation B purchases merchandise from manufacturers or distributors to eventually sell in Corporation B's super retail stores.

Corporations A and C do not purchase from these manufacturers.

Corporation B purchases merchandise from manufactures or distributors to eventually sell in Corporation B's super retail stores.

Corporations A and C purchase from these manufacturers as well.

Corporation C purchases merchandise from manufacturers or distributors to eventually sell in Corporation C's super retail stores.

Corporations A and B do not purchase from these manufacturers.

Corporation C purchases merchandise from manufactures or distributors to eventually sell in Corporation C's super retail stores.

Corporations A and B purchase from these manufacturers, as well.

Corporation A owns and uses resources used to supply super retail stores for Corporation A.

Corporation A has a right to use some resources used to supply super retail stores for Corporation B.

Corporation A has a right to use some resources used to supply super retail stores for Corporation C.

Corporation B has a right to use some resources used to supply super retail stores for Corporation A.

Corporation B owns and uses resources used to supply super retail stores for Corporation B.

Corporation B has a right to use some resources used to supply super retail stores for Corporation C.

Corporation C has a right to use some resources used to supply super retail stores for Corporation A.

Corporation C has a right to use some resources used to supply super retail stores for Corporation B.

Corporation C owns and uses resources used to supply super retail stores for Corporation C.

Corporation A uses the resources used to supply super retail stores for Corporation A to supply super retail stores belonging to Corporation A with some merchandise.

Corporation B uses the resources used to supply super retail stores for Corporation A to supply super retail stores belonging to Corporation B with some merchandise.

Corporation C uses the resources used to supply super retail stores for Corporation A to supply super retail stores belonging to Corporation C with some merchandise.

Corporation A uses the resources used to supply super retail stores for Corporation B to supply super retail stores belonging to Corporation A with some merchandise.

Corporation B uses the resources used to supply super retail stores for Corporation B to supply super retail stores belonging to Corporation B with some merchandise.

Corporation C uses the resources used to supply super retail stores for Corporation B to supply super retail stores belonging to Corporation C with some merchandise.

Corporation A uses the resources used to supply super retail stores for Corporation C to supply super retail stores belonging to Corporation A with some merchandise.

Corporation B uses the resources used to supply super retail stores for Corporation C to supply super retail stores belonging to Corporation B with some merchandise.

Corporation C uses the resources used to supply super retail stores for Corporation C to supply super retail stores belonging to Corporation C with some merchandise.

FIG. 9: Sharing Entirely

Corporation A purchases merchandise from manufacturers or distributors to eventually sell in Corporation A's super retail stores.

Corporations B does not purchase from these manufacturers.

Corporation B purchases merchandise from manufacturers or distributors to eventually sell in Corporation B's super retail stores.

Corporations A does not purchase from these manufacturers.

Corporation B purchases agreed upon merchandise from common manufactures to sell in stores belonging to Corporation A, B, C.

Corporation A acquires the merchandise purchased from common manufacturers purchased by Corporation B for sale in super retail stores belonging to Corporation A.

Corporation A owns and uses resources used to supply super retail stores for Corporation A.

Corporation A has a right to use all resources used to supply super retail stores for Corporation B.

Corporation B has a right to use all resources used to supply super retail stores for Corporation A.

Corporation B owns and uses resources used to supply super retail stores for Corporation B.

Corporation A uses the resources used to supply super retail stores for Corporation A to supply super retail stores belonging to Corporation A with some merchandise.

Corporation B uses the resources used to supply super retail stores for Corporation A to supply super retail stores belonging to Corporation B with some merchandise.

Corporation A uses the resources used to supply super retail stores for Corporation B to supply super retail stores belonging to Corporation A with some merchandise.

Corporation B uses the resources used to supply super retail stores for Corporation B to supply super retail stores belonging to Corporation B with some merchandise.

FIG. 10: Sharing Entirely without Purchasing Collectively

Corporation A purchases merchandise from manufacturers or distributors to eventually sell in Corporation A's super retail stores.

Corporations B does not purchase from these manufacturers.

Corporation A purchases merchandise from manufactures or distributors to eventually sell in Corporation A's super retail stores.

Corporations B purchases from these manufacturers, as well.

Corporation B purchases merchandise from manufacturers or distributors to eventually sell in Corporation B's super retail stores.

Corporations A does not purchase from these manufacturers.

Corporation B purchases merchandise from manufactures or distributors to eventually sell in Corporation B's super retail stores.

Corporations A purchases from these manufacturers, as well.

Corporation A owns and uses resources used to supply super retail stores for Corporation A.

Corporation A has a right to use all resources used to supply super retail stores for Corporation B.

Corporation B has a right to use all resources used to supply super retail stores for Corporation A.

Corporation B owns and uses resources used to supply super retail stores for Corporation B.

Corporation A uses the resources used to supply super retail stores for Corporation A to supply super retail stores belonging to Corporation A with some merchandise.

Corporation B uses the resources used to supply super retail stores for Corporation A to supply super retail stores belonging to Corporation B with some merchandise.

Corporation A uses the resources used to supply super retail stores for Corporation B to supply super retail stores belonging to Corporation A with some merchandise.

Corporation B uses the resources used to supply super retail stores for Corporation B to supply super retail stores belonging to Corporation B with some merchandise.

FIG. 11: Combining Partially and Sharing Partially

Corporation A purchases merchandise from manufacturers or distributors to eventually sell in Corporation A's super retail stores.

Corporations B and C do not purchase from these manufacturers.

Corporation A purchases agreed upon merchandise from common manufactures to sell in stores belonging to the different corporations, A, B, C.

Corporation B purchases merchandise from manufacturers or distributors to eventually sell in Corporation B's super retail stores.

Corporations A and C do not purchase from these manufacturers.

Corporation B purchases agreed upon merchandise from common manufactures to sell in stores belonging to the different corporations, A, B, and C.

X Corp purchases agreed upon merchandise from common manufactures to sell in stores belonging to the different corporations, A, B, and C.

Corporation C purchases agreed upon merchandise from common manufactures to sell in stores belonging to the different corporations, A, B, C.

Corporation C purchases merchandise from manufacturers or distributors to eventually sell in Corporation C's super retail stores.

Corporations A and B do not purchase from these manufacturers.

Corporation A owns and uses resources used to supply super retail stores for Corporation A.

Corporation A has a right to use some resources used to supply super retail stores for Corporation B.

Corporation A has a right to use some resources used to supply super retail stores for Corporation C.

Corporation B has a right to use some resources used to supply super retail stores for Corporation A.

Corporation B owns and uses resources used to supply super retail stores for Corporation B.

Corporation B has a right to use some resources used to supply super retail stores for Corporation C.

X Corp owns and has a right to use resources used to supply super retail stores for X Corp.

Corporation C has a right to use some resources used to supply super retail stores for Corporation A.

Corporation C has a right to use some resources used to supply super retail stores for Corporation B.

Corporation C owns and uses resources used to supply super retail stores for Corporation C.

Corporation A uses the resources used to supply super retail stores for Corporation A to supply super retail stores belonging to Corporation A with some merchandise.

Corporation B uses the resources used to supply super retail stores for Corporation A to supply super retail stores belonging to Corporation B with some merchandise.

Corporation C uses the resources used to supply super retail stores for Corporation A to supply super retail stores belonging to Corporation C with some merchandise.

Corporation A uses the resources used to supply super retail stores for Corporation B to supply super retail stores belonging to Corporation A with some merchandise.

Corporation B uses the resources used to supply super retail stores for Corporation B to supply super retail stores belonging to Corporation B with some merchandise.

Corporation C uses the resources used to supply super retail stores for Corporation B to supply super retail stores belonging to Corporation C with some merchandise.

X Corp uses the resources used to supply super retail stores for X Corp to supply super retail stores belonging to Corporation A with some merchandise.

X Corp uses the resources used to supply super retail stores for X Corp to supply super retail stores belonging to Corporation B with some merchandise.

X Corp uses the resources used to supply super retail stores for X Corp to supply super retail stores belonging to Corporation C with some merchandise.

Corporation A uses the resources used to supply super retail stores for Corporation C to supply super retail stores belonging to Corporation A with some merchandise.

Corporation B uses the resources used to supply super retail stores for Corporation C to supply super retail stores belonging to Corporation B with some merchandise.

Corporation C uses the resources used to supply super retail stores for Corporation C to supply super retail stores belonging to Corporation C with some merchandise.

FIG. 12: Combining Partially and Sharing Partially without Purchasing Collectively

Corporation A purchases merchandise from manufacturers or distributors to eventually sell in Corporation A's super retail stores.

Corporations B and C do not purchase from these manufacturers.

Corporation A purchases merchandise from manufactures or distributors to eventually sell in Corporation A's super retail stores.

Corporations B and C purchase from these manufacturers, as well.

Corporation B purchases merchandise from manufacturers or distributors to eventually sell in Corporation B's super retail stores.

Corporations A and C do not purchase from these manufacturers.

Corporation B purchases merchandise from manufactures or distributors to eventually sell in Corporation B's super retail stores.

Corporations A and C purchase from these manufacturers as well.

Corporation C purchases merchandise from manufacturers or distributors to eventually sell in Corporation C's super retail stores.

Corporations A and B do not purchase from these manufacturers.

Corporation C purchases merchandise from manufactures or distributors to eventually sell in Corporation C's super retail stores.

Corporations A and B purchase from these manufacturers, as well.

Corporation A owns and uses resources used to supply super retail stores for Corporation A.

Corporation A has a right to use some resources used to supply super retail stores for Corporation B.

Corporation A has a right to use some resources used to supply super retail stores for Corporation C.

Corporation B has a right to use some resources used to supply super retail stores for Corporation A.

Corporation B owns and uses resources used to supply super retail stores for Corporation B.

Corporation B has a right to use some resources used to supply super retail stores for Corporation C.

X Corp owns and has a right to use resources used to supply super retail stores for X Corp.

Corporation C has a right to use some resources used to supply super retail stores for Corporation A.

Corporation C has a right to use some resources used to supply super retail stores for Corporation B.

Corporation C owns and uses resources used to supply super retail stores for Corporation C.

Corporation A uses the resources used to supply super retail stores for Corporation A to supply super retail stores belonging to Corporation A with some merchandise.

Corporation B uses the resources used to supply super retail stores for Corporation A to supply super retail stores belonging to Corporation B with some merchandise.

Corporation C uses the resources used to supply super retail stores for Corporation A to supply super retail stores belonging to Corporation C with some merchandise.

Corporation A uses the resources used to supply super retail stores for Corporation B to supply super retail stores belonging to Corporation A with some merchandise.

Corporation B uses the resources used to supply super retail stores for Corporation B to supply super retail stores belonging to Corporation B with some merchandise.

Corporation C uses the resources used to supply super retail stores for Corporation B to supply super retail stores belonging to Corporation C with some merchandise.

X Corp uses the resources used to supply super retail stores for X Corp to supply super retail stores belonging to Corporation A with some merchandise.

X Corp uses the resources used to supply super retail stores for X Corp to supply super retail stores belonging to Corporation B with some merchandise.

X Corp uses the resources used to supply super retail stores for X Corp to supply super retail stores belonging to Corporation C with some merchandise.

Corporation A uses the resources used to supply super retail stores for Corporation C to supply super retail stores belonging to Corporation A with some merchandise.

Corporation B uses the resources used to supply super retail stores for Corporation C to supply super retail stores belonging to Corporation B with some merchandise.

Corporation C uses the resources used to supply super retail stores for Corporation C to supply super retail stores belonging to Corporation C with some merchandise.

FIG. 13: Combining Partially and Sharing Entirely

Corporation A purchases merchandise from manufacturers or distributors to eventually sell in Corporation A's super retail stores.

Corporations B and C do not purchase from these manufacturers.

Corporation A purchases agreed upon merchandise from common manufactures to sell in stores belonging to the different corporations, A, B, C.

Corporation B purchases merchandise from manufacturers or distributors to eventually sell in Corporation B's super retail stores.

Corporations A and C do not purchase from these manufacturers.

Corporation B purchases agreed upon merchandise from common manufactures to sell in stores belonging to the different corporations, A, B, and C.

X Corp purchases agreed upon merchandise from common manufactures to sell in stores belonging to the different corporations, A, B, and C.

Corporation C purchases agreed upon merchandise from common manufactures to sell in stores belonging to the different corporations, A, B, C.

Corporation C purchases merchandise from manufacturers or distributors to eventually sell in Corporation C's super retail stores.

Corporations A and B do not purchase from these manufacturers.

Corporation A owns and uses resources used to supply super retail stores for Corporation A.

Corporation A has a right to use all resources used to supply super retail stores for Corporation B.

Corporation A has a right to use all resources used to supply super retail stores for Corporation C.

Corporation B has a right to use all resources used to supply super retail stores for Corporation A.

Corporation B owns and uses resources used to supply super retail stores for Corporation B.

Corporation B has a right to use all resources used to supply super retail stores for Corporation C.

X Corp owns and has a right to use resources used to supply super retail stores for X Corp.

Corporation C has a right to use all resources used to supply super retail stores for Corporation A.

Corporation C has a right to use all resources used to supply super retail stores for Corporation B.

Corporation C owns and uses resources used to supply super retail stores for Corporation C.

Corporation A uses the resources used to supply super retail stores for Corporation A to supply super retail stores belonging to Corporation A with some merchandise.

Corporation B uses the resources used to supply super retail stores for Corporation A to supply super retail stores belonging to Corporation B with some merchandise.

Corporation C uses the resources used to supply super retail stores for Corporation A to supply super retail stores belonging to Corporation C with some merchandise.

Corporation A uses the resources used to supply super retail stores for Corporation B to supply super retail stores belonging to Corporation A with some merchandise.

Corporation B uses the resources used to supply super retail stores for Corporation B to supply super retail stores belonging to Corporation B with some merchandise.

Corporation C uses the resources used to supply super retail stores for Corporation B to supply super retail stores belonging to Corporation C with some merchandise.

X Corp uses the resources used to supply super retail stores for X Corp to supply super retail stores belonging to Corporation A with some merchandise.

X Corp uses the resources used to supply super retail stores for X Corp to supply super retail stores belonging to Corporation B with some merchandise.

X Corp uses the resources used to supply super retail stores for X Corp to supply super retail stores belonging to Corporation C with some merchandise.

Corporation A uses the resources used to supply super retail stores for Corporation C to supply super retail stores belonging to Corporation A with some merchandise.

Corporation B uses the resources used to supply super retail stores for Corporation C to supply super retail stores belonging to Corporation B with some merchandise.

Corporation C uses the resources used to supply super retail stores for Corporation C to supply super retail stores belonging to Corporation C with some merchandise.

FIG. 14: Combining Partially and Sharing Entirely without Purchasing Collectively

Corporation A purchases merchandise from manufacturers or distributors to eventually sell in Corporation A's super retail stores.

Corporations B and C do not purchase from these manufacturers.

Corporation A purchases merchandise from manufactures or distributors to eventually sell in Corporation A's super retail stores.

Corporations B and C purchase from these manufacturers, as well.

Corporation B purchases merchandise from manufacturers or distributors to eventually sell in Corporation B's super retail stores.

Corporations A and C do not purchase from these manufacturers.

Corporation B purchases merchandise from manufactures or distributors to eventually sell in Corporation B's super retail stores.

Corporations A and C purchase from these manufacturers as well.

Corporation C purchases merchandise from manufacturers or distributors to eventually sell in Corporation C's super retail stores.

Corporations A and B do not purchase from these manufacturers.

Corporation C purchases merchandise from manufactures or distributors to eventually sell in Corporation C's super retail stores.

Corporations A and B purchase from these manufacturers, as well.

Corporation A owns and uses resources used to supply super retail stores for Corporation A.

Corporation A has a right to use all resources used to supply super retail stores for Corporation B.

Corporation A has a right to use all resources used to supply super retail stores for Corporation C.

Corporation B has a right to use all resources used to supply super retail stores for Corporation A.

Corporation B owns and uses resources used to supply super retail stores for Corporation B.

Corporation B has a right to use all resources used to supply super retail stores for Corporation C.

X Corp owns and has a right to use resources used to supply super retail stores for X Corp.

Corporation C has a right to use all resources used to supply super retail stores for Corporation A.

Corporation C has a right to use all resources used to supply super retail stores for Corporation B.

Corporation C owns and uses resources used to supply super retail stores for Corporation C.

Corporation A uses the resources used to supply super retail stores for Corporation A to supply super retail stores belonging to Corporation A with some merchandise.

Corporation B uses the resources used to supply super retail stores for Corporation A to supply super retail stores belonging to Corporation B with some merchandise.

Corporation C uses the resources used to supply super retail stores for Corporation A to supply super retail stores belonging to Corporation C with some merchandise.

Corporation A uses the resources used to supply super retail stores for Corporation B to supply super retail stores belonging to Corporation A with some merchandise.

Corporation B uses the resources used to supply super retail stores for Corporation B to supply super retail stores belonging to Corporation B with some merchandise.

Corporation C uses the resources used to supply super retail stores for Corporation B to supply super retail stores belonging to Corporation C with some merchandise.

X Corp uses the resources used to supply super retail stores for X Corp to supply super retail stores belonging to Corporation A with some merchandise.

X Corp uses the resources used to supply super retail stores for X Corp to supply super retail stores belonging to Corporation B with some merchandise.

X Corp uses the resources used to supply super retail stores for X Corp to supply super retail stores belonging to Corporation C with some merchandise.

Corporation A uses the resources used to supply super retail stores for Corporation C to supply super retail stores belonging to

Corporation A with some merchandise.

Corporation B uses the resources used to supply super retail stores for Corporation C to supply super retail stores belonging to Corporation B with some merchandise.

Corporation C uses the resources used to supply super retail stores for Corporation C to supply super retail stores belonging to Corporation C with some merchandise.

### DEFINITIONS

Definition List 1

Term: Super retail store
Definition: a store which is larger than 100,000 square feet, sells general merchandise, and grocery products, offers approximately 100,000 different items including grocery products, employs between approximately 200 and 550 associates.

Term: Goods
Definition: items for sale in super retail stores.

Term: Common Goods
Definition: Items for sale in super retail stores, which are bought from the same manufacturer or supplier.

Term: Supply lines
Definition: Assets owned by a corporation in the retail goods industry, which are used in receiving the product from the manufacture and transporting the product to the super retail store. For the purpose of this patent, there are four major areas of supply lines: purchasing the merchandise, transportation of the merchandise, storage of merchandise, and management of the merchandise.

Term: Supplying
Definition: the process by which merchandise travels from the manufacturer to the super retail store, which includes the management, purchase, transportation, and storage of the merchandise.

Term: Business Organization
Definition: any organization which is recognized, and taxed as a business under federal tax statutes, or is owned by an organization so taxed. Holding corporations are considered a type of business organizations.

Term: Collaborative agreement
Definition: An agreement between two or more business organizations in the form of a legal document, which states the relationship between the organizations. Relevant Examples: contractual agreement involving the sharing and/or combining of resources used to supply stores, creation of a new corporate entity, such as a limited liability partnership, which involves the sharing and/or combining of resources used to supply stores, strategic alliances, joint venture partnership, joint venture corporation, confidentiality and non-disclosure agreements.

Term: To combine entirely
Definition: Combining entirely means there is an actual transfer of ownership of all resources used to supply super retail stores by a business organization operating or seeking to operate super retail stores to another entity or other entities.

Term: To combine partially
Definition: Combining partially means there is an actual transfer of ownership of some resources used to supply super retail stores by a business organization operating or seeking to operate super retail stores to another entity or other entities.

Term: To share entirely
Definition: Sharing entirely means a business organization operating or seeking to operate super retail stores gives another business organization or other business organizations the right to use all of their resources used to supply super retail stores in exchange for the right to use all of the resources used to supply super retail stores of the other organization(s).

Term: To share partially
Definition: Sharing partially means a business organization operating or seeking to operate super retail stores gives another business organization or other business organizations the right to use some resources used to supply super retail stores in exchange for the right to use some of the resources used to supply super retail stores of the other organization(s).

Term: Corporate resources used to supply stores
Definition: all corporate assets, which are used in acquiring, transporting, storing, organizing, and managing products during the process of taking the product from the manufacture to the super retail store including but not limited by the following elements: computer product information; trucks, train cars, warehouses, import warehouses, distribution centers, supply depots, surplus depots, employees, contractual agreements, made for acquiring, transporting, storing, organizing, and managing products during the process of taking the product from the manufacture to the retail store

Term: Retailer
Definition: A business organization which operates super retail stores.

What is claimed is:

1. A method for supplying super retail store by a business organization operating or seeking to operate super retail stores, which comprises: (1) combining partially resources used to supply super retail stores with the resources used to supply super retail stores of another business organization or other business organizations, who operate(s) or seek(s) to operate super retail stores; (2) purchasing collectively some or all goods from common manufactures; (3) purchasing and supplying super retail stores using the additional resources.

2. The method of claim 1 wherein, the business organizations do not purchase collectively some or all goods from common manufactures.

3. A method for supplying super retail store by a business organization operating or seeking to operate super retail stores, which comprises: (1) combining entirely resources used to supply super retail stores with the resources used to supply super retail stores of another business organization or other business organizations, who operate(s) or seek(s) to operate super retail stores; (2) purchasing collectively some or all goods from common manufacturers; (3) purchasing and supplying super retail stores using the additional resources.

4. The method of claim 3 wherein, the business organizations do not purchase collectively some or all goods from common manufactures.

5. A method for supplying super retail store by a business organization operating or seeking to operate super retail stores, which comprises: (1) sharing partially resources used to supply super retail stores with the resources used to supply super retail stores of another business organization or other business organizations, who operate(s) or seek(s) to operate super retail stores; (2) purchasing collectively some or all goods from common manufacturers; (3) purchasing and supplying super retail stores using the additional resources.

6. The method of claim 5 wherein, the business organizations do not purchase collectively some or all goods from common manufactures.

7. A method for supplying super retail store by a business organization operating or seeking to operate super retail stores, which comprises: (1) sharing entirely resources used to supply super retail stores with the resources used to supply super retail stores of another business organization or other business organizations, who operate(s) or seek(s) to operate super retail stores; (2) purchasing collectively some or all goods from common manufacturers; (3) purchasing and supplying super retail stores using the additional resources.

8. The method of claim 7 wherein, the business organizations do not purchase collectively some or all goods from common manufactures.

9. A method for supplying super retail store by a business organization operating or seeking to operate super retail stores, which comprises: (1) combining partially and sharing partially resources used to supply super retail stores with the resources used to supply super retail stores of another business organization or other business organizations, who operate(s) or seek(s) to operate super retail stores; (2) purchasing collectively some or all goods from common manufacturers; (3) purchasing and supplying super retail stores using the additional resources.

10. The method of claim 9 wherein, the business organizations do not purchase collectively some or all goods from common manufactures.

11. A method for supplying super retail store by a business organization operating or seeking to operate super retail stores, which comprises: (1) combining partially and sharing entirely resources used to supply super retail stores with the resources used to supply super retail stores of another business organization or other business organizations, who operate(s) or seek(s) to operate super retail stores; (2) purchasing collectively some or all goods from common manufacturers; (3) purchasing and supplying super retail stores using the additional resources.

12. The method of claim 11 wherein, the business organizations do not purchase collectively some or all goods from common manufactures.
